(19) United States
(12) Patent Application Publication
(10) Pub. No.: US 2004/0257241 A1
(43) Pub. Date: Dec. 23, 2004

(54) METHOD AND APPARATUS FOR TRANSPORTING DATA

(76) Inventor: Stefan K. Menger, Exton, PA (US)

Correspondence Address: JONES DAY, 222 EAST 41ST ST, NEW YORK, NY, 10017, US

(21) Appl. No.: 10/142,811

(22) Filed: May 10, 2002

(51) Int. Cl. G01V 3/00

(52) U.S. Cl. 340/854.3

(57) ABSTRACT

A method and system for data transmission where data is encoded in a number of messenger modules that are physically transported by a natural or artificially created fluid flow or in a slurry stream from one location to one or more other locations to transmit the data. In a specific embodiment, the invention is directed to the use of such messenger modules for continuous, quasi-continuous or time-dependent data transmission between surface-based equipment and a logging tool placed in a borehole and vice versa, or between various locations in the borehole.

### 1. FIELD OF THE INVENTION

This invention relates generally to data transmission and more particularly to systems and methods for encoding data in a number of messenger modules that are physically transported by a fluid flow or in a slurry stream from one location to one or more other locations to transmit the data. In a specific embodiment, the invention is directed to the use of such messenger modules for continuous, quasi-continuous or time-dependent data transmission between surface-based equipment and a logging tool placed in a borehole and vice versa, or between various locations in the borehole.

### 2. BACKGROUND OF THE INVENTION

In many applications it is of interest to communicate to a user information obtained at various remote locations. Examples pertinent to this disclosure include evaluating the flow of fluids, monitoring changes in physical conditions over time, effectively communicating between several locations, and the like. To provide such communications, it is not always possible or even economically reasonable to lay down wired links or use wireless connections due to rugged terrain, desired reliability, or attenuation of electromagnetic or acoustic signals. For example, sites that are exposed to significant moisture may strongly attenuate radio-frequency signals. It may simply be prohibitively expensive to provide a reliable and fast communication of information from a borehole in various applications, including oil, and natural gas exploration, analyzing core samples, and others. The challenges in establishing and maintaining reliable communications are well known problems in the arts of borehole drilling and logging, which are used in this application as primary illustrative examples.

Thus, in well logging applications it is desired to map out and understand the structure of the formation(s) surrounding a borehole. The required information is available from various logging tools that measure different physical, chemical, electrical and other parameters of the formation, which have well-known interpretations. However, it is quite difficult to obtain quickly and reliably such information directly from the tools using standard communication channels. This is because of the significant challenges to establishing and maintaining, for example, a wire-based communication channels between the tool in the borehole and the surface in the extreme conditions of heat, pressure and mechanical wear and tear of a typical borehole environment.

Geologists and geophysicists are interested in the geological formations encountered during drilling. Techniques such as “Measurement-While-Drilling” or “Logging-While-Drilling” (“MWD” or “LWD”, respectively) facilitate collection of data by means of tools mounted on a drill string immediately above the drill bit. The collected data is typically sent to the surface by transmissions via radio-frequency, acoustic waves and mud pulsers. All of these techniques are severely limited by the distances over which data needs to be transmitted and the available bandwidth. Similar difficulties attend the use of shuttles that are sent with the help of a wire or flushed down to dock and collect data from the tools and return with the information in deep wells, such as the exemplary borehole described next.

FIG. 1 illustrates a mud pulsing system and the environment presented by boreholes in general. Drilling rig 10 (simplified to exclude items not important to this application) comprises derrick 12, derrick floor 14, draw works 16, hook 18, swivel 20, kelly joint 22, rotary table 24, drill string 26, drill collar 28, LWD tool 30, LWD tool 32, and drill bit 34. While two LWD tools are shown, any number of such tools could be included. Mud is injected into swivel 20 by mud supply line 36 and travels through kelly joint 22, through a passage in drill string 26, through drill collar 28, through LWD tools 30 and 32, and finally exits through ports in drill bit 34. Next, mud flows up the annulus of borehole 38. Mud return line 40 returns mud from borehole 38 and circulates it through mud screen 42. Mud screen 42 separates waste from the mud, which is dumped into waste receptacle 44 followed by circulation of mud through ancillary equipment 46 including sand traps and degassers. The mud from ancillary equipment 46 empties into mud pit 48. Mud pump 50 pumps mud out of mud pit 48 and returns it to the borehole 38 via mud return line 36.

Traditionally, data collected by LWD tools 30 and 32 is returned to the surface for analysis using a mud pulsing system. Telemetry transmitter 52 located in drill collar 28 or in one of the LWD tools, collects data from the LWD tools and modulates the data onto a carrier transmitted through the mud as acoustic vibrations. Telemetry sensor 54 on the surface detects the carrier and forwards it to demodulator 56. Following demodulation computing equipment 60 analyzes the data to extract geological information and drilling parameters or well parameters including accuracy estimates.

In a similar arrangement shown in FIG. 2, after the well has been drilled, wireline tool 62 is lowered into borehole 38, suspended by electrical cable 64. Another existing data transmission system utilizes “shuttles.” A shuttle is sent downhole via a wireline or it is flushed downhole. The shuttle makes a temporary, and most of time physical, connection with the downhole device and data is read into the shuttle memory. The shuttle is then pulled or flushed out and the data is retrieved for processing. This method, however, is not always a viable option, as wireline deployment and reverse flushing of the shuttle are not always operational options.

In view of the above, it is apparent that in the ever-deeper boreholes in many current applications the actual bandwidth of a channel corresponding to mud pulsers is limited, as well as susceptible to failure. Similarly, using radio-frequency (RF) communications is compromised by the attenuation due to the presence of water, metal and rock. Providing reliable wired connections for shuttles is impractical in view of the great depths encountered in drilling operations, and the limited range of such communications.

Thus, as exemplified in the case of well logging, considerable challenges still exist in the area of providing robust communications in rugged environments where traditional communication mechanisms are impractical or difficult to implement. Other practical applications that can benefit from improved communications include, without limitations, monitoring coolant systems, pipe-based fluid distribution systems, and monitoring the status of other fluid-based environments, such as lakes, rivers, and others.

### 3. SUMMARY OF THE INVENTION

In accordance with the present invention, deficiencies associated with the prior art are overcome using a number of small-size memory modules, used as “messengers”—thus referred to as messenger modules. Messenger modules are used to load the desired information in memory. A naturally occurring or artificially created fluid flow then carries the messenger modules with the information loaded to one or more receiver locations, where the information can be unloaded, decoded (if necessary) and sent for further processing. In applications where the information source generates substantial amounts of data, or if the data is generated over a period of time, the corresponding data stream is partitioned into short messages that can be loaded into successive groups of messenger modules. At the receiver, the original data stream, as well as additional information, such as the geographic origin of each message and the time it was generated, can be restored using time stamping, message numbering or other indexing techniques. In a preferred embodiment, the messenger modules of this invention are inexpensive, making it economically feasible to use redundant modules to ensure reliability of the communication links.

More specifically, in one aspect the invention is a method for data transmission in a borehole comprising: collecting data regarding properties of at least one material; imparting collected data for storage into a plurality of messenger modules within the borehole, the messenger modules transported via a fluid flow from a first location to a second location; collecting messenger modules in the fluid flow within the borehole; retrieving data stored in the collected messenger modules; and processing the retrieved data. In various embodiments the method is practiced using a measurement tool, such as neutron, density, sonic, resistivity or nuclear magnetic resonance (NMR) logging tool, acoustic imaging tool, directional sensors, mechanical tools, industrial tools and others. In various embodiments the step of imparting comprises one or more of: electromagnetic, optical or acoustical data transmission to at least one messenger module. Further, at least some messenger modules may comprise a housing configured to protect the memory and the transducer, and may also have physical dimensions enabling the messenger module to be carried in a fluid flow. In specific embodiments a signal may be used for powering an on-board electronic circuit in at least one of the messenger modules.

In another aspect, the invention is a method for operating tools deployed in a borehole, which comprises the steps of: providing a sequence of instructions concerning a desired operation of a tool in the borehole; imparting the generated sequence of instructions for storage into one or more messenger modules, the messenger modules having dimensions enabling them to be carried in a fluid flow within the borehole; releasing the one or more messenger modules with stored instructions in a fluid flow within the borehole, the path of the fluid flow carrying such messenger modules near the tool; retrieving messenger modules released in the fluid flow at the tool; extracting the generated sequence of instructions from one or more messenger modules retrieved at the tool; and programming the operation of the tool to conform with the provided sequence of instructions. In another aspect, the invention is a method for gathering data regarding material(s) inside or surrounding a borehole comprising: providing a plurality of messenger modules having dimensions enabling them to be carried in a fluid flow within the borehole; gathering data concerning properties of the formation using one or more sensors located in a messenger module, and storing the gathered data in the messenger module; collecting one or more messenger modules with stored data in the fluid flow within the borehole; retrieving data stored in the collected messenger modules; and processing the retrieved data to determine properties of the geologic formation surrounding the borehole.

In yet another aspect, the invention is a data transmission system, comprising: a plurality of messenger modules for storing data, the messenger modules having physical dimensions enabling them to be carried in a fluid flow; and at least one reader responsive to a member of the set consisting of electromagnetic signal or acoustic signal, positioned in a predetermined fluid flow path, the reader configured to receive data stored in a messenger module that is carried by the fluid flow near the reader.

In yet another aspect, the invention is a messenger module having a plurality of circuits for use in a data transmission system assisted by a fluid flow, the messenger module comprising: a memory for storing data; a receiver for receiving data from an external source; a transmitter for providing data to an external sink; a housing; and at least one sensor for detecting the external sink.

In another aspect, the invention is a system for transmission of data in a borehole comprising: a plurality of messenger modules storing data, the modules having physical dimensions enabling them to be carried in a fluid flow; a data transmission device receiving fluid from the fluid flow, the device capable of loading data to messenger modules located in its vicinity; a receiver collecting data stored in messenger modules and transmitting the collected data for processing.

Additional aspects of the invention are discussed below in the detailed description of the preferred embodiments.

### 4. BRIEF DESCRIPTION OF THE DRAWINGS

FIG. 1 depicts a data transmission system employing mud pulsers;

FIG. 2 depicts a data transmission system utilizing a wireline tool;

FIG. 3 is a block diagram depicting the path of the messenger modules from above the surface to below the surface and vice versa, according to the present invention;

FIG. 4 depicts the interaction of the messenger modules with LWD tools on a drill string in the depths of a borehole;

FIG. 5 is a cross-sectional view of a LWD tool according to the present invention;

FIG. 6 depicts the separation of the messenger modules from the mud stream inside a LWD tool, and subsequent transmittal/receival of data to and from the messenger modules;

FIG. 7 is a block diagram depicting the internal circuitry of the messenger module transmitter/receiver;

FIG. 8 is a block diagram depicting the internal circuitry of the memory component in the messenger module transmitter/receiver;

FIG. 9 is a block diagram depicting the internal circuitry of the transmitter/receiver in the messenger module transmitter/receiver;

FIG. 10 is a flowchart illustrating the process by which the data collection controller changes from transmit mode to receive mode;

FIG. 11 is a block diagram depicting the internal circuitry of the data collection controller in the messenger module transmitter/receiver;

FIG. 12 shows the internal circuitry and shape of the messenger module;

FIG. 13 is a top plan view of the messenger module;

FIG. 14 is a block diagram depicting the internal circuitry of the messenger module;

FIG. 15 is a block diagram depicting the transmittal and receipt of data by the messenger module;

FIG. 16 is an alternative embodiment of the present invention, depicting the separation of the messenger modules from the mud stream inside a LWD tool using a capture device or gate, and subsequent transmittal/receival of data to and from the messenger modules;

FIG. 17 depicts the messenger module in the alternative embodiment of FIG. 16;

FIG. 18 depicts the interaction between the messenger module and the spring-loaded contact in the alternative embodiment of FIGS. 16 and 17;

FIG. 19 is a block diagram of the internal circuitry of the messenger module transmitter/receiver in the alternative embodiment of FIGS. 16, 17, and 18;

FIG. 20 is a block diagram depicting the internal circuitry of the messenger module in the alternative embodiment of FIGS. 16, 17, and 18;

FIG. 21 depicts the data stream transmitted by the messenger module transmitter/receiver, embedded with time stamps;

FIG. 22 depicts the data stream of FIG. 21 with an error detection correction code;

FIG. 23 depicts the procedure of how data streams with gaps may be reconstructed using patterns within the data itself;

FIG. 24 is a block diagram depicting the internal circuitry of a messenger module with a sensor;

FIG. 25 depicts the collection of data using sensor-equipped messenger modules;

FIG. 26 depicts the collection of data by messenger modules from behind an oil well casing;

FIG. 27 depicts the collection of data by messenger modules from behind an oil well casing where the messenger module is in direct contact with the borehole wall;

FIG. 28 depicts the recovery of data from a stranded oil tool;

FIG. 29 depicts a messenger module without its housing, the particular messenger module employing optical communications; and

FIG. 30 depicts messenger modules being utilized in a relay communications technique.

### 5. DETAILED DESCRIPTION OF THE INVENTION

Modern telecommunication is typically based on transmission of data between different physical locations using electromagnetic or acoustic waves. For most practical applications this communication model ensures fast, continuous and reliable data transmission. But in some cases it is either impossible to use such waves, or the range in which they can operate is very limited. Illustrative examples in this regard are downhole applications, where logging tools acquire or generate valuable data regarding the structure of the formation surrounding a borehole, but are very limited in terms of how the acquired data can be communicated to the surface, especially when there is no wireline connection.

5.1 Basic Approach

In accordance with the present invention, one approach to solving the above problems and achieving a continuous, quasi-continuous, or time-dependent data stream is to cause a number of small-size memory modules, referred to in this application as messenger modules, to pass near an information source or physically attach to the source in order to load the desired information. A naturally occurring or artificially created fluid flow then carries the messenger modules with the information loaded to one or more receiver locations, where the information can be unloaded, decoded (if necessary) and sent for further processing. In applications where the information source generates substantial amounts of data (or if the data is generated over a period of time), in accordance with this invention the corresponding data stream may be partitioned into short messages that can be loaded into successive groups of messenger modules. In other applications it may be desirable to fit the entire message into the memory of a single messenger module (or multiple redundant modules). At the receiver end the original data stream, as well as additional information, such as the geographic origin of each message and the time it was generated, can be restored using time stamping, message numbering or other indexing techniques. In a preferred embodiment, the messenger modules of this invention are inexpensive, making it economically feasible to use redundant modules to ensure reliability of the communication links.

It will be apparent that the amount of data that can be communicated in accordance with the present invention depends on the data capacity of the modules and the specific means for transporting modules from one location to another, including the speed of transmission. In one embodiment, messenger modules used in accordance with the present invention are made using semiconductor technology. It is expected therefore, that improvements in semiconductor fabrication technology, which at the time of this application are approximately exponential in accordance with Moore's law, should result in the future in an increase in the storage capacities and thus in the achievable data rate for communication, all with further reduction in costs.

5.1.1 Communications Using Non-sinusoidal Radiation

In another aspect of the present invention, information exchange with messenger modules is accomplished using non-sinusoidal radiation for ultra-wideband communication via trains of pulses. Non-sinusoidal radiation is useful for developing miniaturized networking-enabled devices that do not employ conventional sinusoidal waveforms for radio transmissions. Thus, in one embodiment of the invention, a pair of impulses are transmitted with an associated broad bandwidth resulting in low power in any particular frequency range. Notably, in this scheme there is no requirement for a carrier frequency or its modulation to carry a signal in the manner familiar with resonance-based sinusoidal communication systems. Further details about the technology can be found in the Semi-Annual Technical Report # J-FBI-94-058, “Low-Power, Miniature, Distributed Position Location and Communication Devices Using Ultra-Wideband, Nonsinusoidal Communication Technology” prepared for the Advanced Research Projects Agency/Federal Bureau of Investigation in July 1995, available at the time of submission of this application at http:/www.aetherwire.com/PI_Report_{—}95/pi_rep95.html. The content of the report is incorporated herein by reference in its entirety. Additional discussion of non-sinusoidal radiation based communications and miniaturizable antennas suitable for such ultra-wideband communications is found in the U.S. Pat. No. 4,506,267 issued to Henning F. Harmuth on Mar. 19, 1985, which is also incorporated herein by reference.

In addition, fabrication of modules employing non-sinusoidal radiation in accordance with one aspect of the present invention allows further reduction in the size of the modules since the electronics can be integrated by, e.g., complementary metal oxide transistor (“CMOS”)-based fabrication with no inductive components. The non-resonant and current mode antennas are also small and directly driven by CMOS. Ultra-wideband communication enabled by nonsinusoidal radiation also offers the advantage of using lower frequencies resulting in less attenuation. Moreover, the signals are resistant to interference due to little energy being present in any particular narrow frequency band. In a preferred embodiment, more than one messenger module may be used to transmit data from one physical location to another in order to increase the robustness of the system and minimize the risk that data can be lost with the loss or disablement of any particular messenger module.

5.1.2 Providing Data Communication in a Borehole

The principles of this invention are illustrated in the following description in the previously described context of a borehole. Thus, in one embodiment of this invention, messenger modules having suitable data storage capacity are flushed downhole from the surface to the tool(s) that are placed in the borehole. In the following description these tools themselves are considered as information sources that acquire data concerning the properties of the surrounding formation. The specific selection of tools that can be used in any particular application is immaterial, but for the interested reader a non-exhaustive list includes a (standard) set of logging tools such as Gamma, Density, Neutron, Resistivity, Sonic, Induction, NMR, Resistivity Borehole Imager, Acoustic Borehole Imager, Caliper, Dipmeter, Temperature, and SP Tool (Spontaneous Potential), among others.

In accordance with one aspect of the present invention, data generated by the tool(s) is then stored in the memory of the messenger modules using a transmitter. The modules are then circulated back to the surface, where the data may be retrieved and processed. Data may additionally or in the alternative be stored on the messenger modules at the surface and then circulated to the tools in the borehole, where the data can be retrieved and then used, for example, to re-program the tool, to initiate a processing sequence, changing its mode of operation or work parameters, or for other purposes. In yet another embodiment of the invention data may be stored on one or more messenger modules at one location in the borehole and circulated to a second location in the borehole where the data may be retrieved. Thus, messenger modules carried by natural or artificially created fluid flow enable communication or exchange of information between various tools and sensors in a borehole, effectively networking them.

5.2 System Components

The main components of a system in accordance with the present invention can broadly be classified into a data transmitter module, one or more messenger modules capable of storing information generated by the transmitter, a data receiver module and a fluid flow capable of physically carrying the messenger modules between the transmitter and the receiver modules along with many variants of the system. The description of the system components begins with the messenger modules.

5.2.1 The Messenger Modules

An exemplary messenger module used in a preferred embodiment is small-sized, packaged for protection against hostile environment, such as corrosion due to water and mud, exposure to gas, radiation or electromagnetic fields, or damage by vibrations and mud flow in a borehole. In accordance with the invention, the specific dimensions depend on the manufacturing technology, the memory requirements of the application and the parameters of the fluid flow that is expected to carry the modules. In a preferred embodiment, the messenger modules consume very little power since they remain in a sleeping state except for brief periods of activity when data is delivered or received. The low power requirements of the messenger module in a preferred embodiment enable various designs, such as zero-power sensors that are driven by the power in the received signal itself In alternate embodiments, memory and other circuits of the messenger modules may be powered by vibration or other conditions in the environment. Alternatively, in some embodiments of the invention, an on-board source of power, such as a battery that may optionally be charged, e.g., via photoelectric effect and the like. Alternative sources for the powering may be used as they are developed in the future.

Exemplary embodiments of the invention employ a variety of data transmission approaches. For instance, light, wireless—both sinusoidal and non-sinusoidal, direct electrical contacts, and the like are all compatible with the design of messenger modules in accordance with this invention. Since messenger modules in this invention generally interact with external devices to receive and provide data, such external devices are designed to provide complimentary communication capabilities. Therefore, the description of various technologies in the context of messenger modules in general also applies to similar design issues to external components, such as the programmer (typically placed close to a measurement tool), a reader (usually at the surface), with which messenger modules exchange data, and others.

In one embodiment, the messenger modules are also highly integrated to provide memory that is resistant to power failures. As stated above, preferably messenger modules may have processing power on board. However, it is possible to have messenger modules that are akin to memory chips that are entirely driven by external components for both writing and reading data. When not interacting with external components, these types of messenger modules used in accordance with the invention do little more than hold data. Preferably, the onboard processing power, if present, is driven by clocks at different rates to conserve power with slower clocks running during the sleep state and faster clocks deployed when fast responses are needed. The switch from sleep to active states or from a data receiving state to a data transmitting state are advantageously data-driven. However, the data-driven design or multiple clock rates are not intended to be a limitation on the scope of the invention, since even with a single clock rate messenger modules can operate satisfactorily for many of the intended applications and take advantage of advances in fabrication technology to reduce costs and increase data holding capacity.

Over the last few years, memory chips have become drastically smaller in size. For example, it is well within the capabilities of today's technology to pack mega-bits of storage capacity in a few cubic millimeters of space. Importantly, such technology is developed to a degree that makes it economically feasible to use such memory chips in virtually all aspects of modern life. In accordance with a preferred embodiment of the present invention, messenger modules are in the group of highly miniaturized products known as “smart dust.” A description of smart dust-type modules is provided, for example, at the time of writing at http://robotics.eecs.berkeley.edu˜pister/SmartDust/, and is incorporated herein by reference.

5.2.1.1 Introduction to Smart Dust

The development of improved fabrication techniques for semiconductor-based devices has made possible new modes of data transmission and networking. Economic fabrication of devices small enough to be considered “smart dust” enables devices no larger than a few cubic millimeters that include millions of bits of memory and processing circuitry.

The currently available smart dust modules are very small (the size of a fraction of a penny), bottle-cap-shaped micro-machines fitted with wireless communication devices—that measure parameters such as light and temperature. When clustered together, they are expected to create highly flexible, low-power networks with applications ranging from climate-control systems to entertainment devices that interact with handheld computers.

Smart dust technology and its ongoing development is further described in the following articles, which are incorporated herein by reference in their entirety, found at the time this application was filed at http//robotics.eecs.berkeley.edukpister/SmartDust: J. M. Kahn, R. H. Katz, K. S. J. Pister, Next Century Challenges: Mobile Networking for “Smart Dust” (undated); Kristofer S. J. Pister, Joseph M. Kahn, and Bernhard E. Boser. Smart Dust: Wireless Networks of Millimeter Scale Sensor Nodes (Dec. 10, 1998); V. S. Hsu, J. M. Kahn and K. S. J. Pister, Wireless Communications for Smart Dust (Jan. 30, 1998); Kris Pister, Joe Kahn, Bernhard Boser, Smart Dust: Autonomous Sensing and Communication in a Cubic Millimeter Matthew Last, K. S. J. Pister, 2-DOF Actuated Micromirror Designed for Large DC Deflection (undated); and Richard Yeh, Robert A. Conant, and Kristofer S. J. Pister, Mechanical Digital-to-Analog Converters (undated).

In the context of this invention, the structure of the messenger modules and their inner workings admit of many variations. The messenger modules are capable of reliably storing information, and that they can be encapsulated in a protective coating for effectively shielding them. In addition, it is desirable that the messenger modules are shaped to be compatible with movement along the path of the fluid flow.

5.2.1.2 Shape of a Messenger Module

Although the invention does not place a particular restriction on the shape of the messenger modules in general, some shapes are more suitable for particular applications. For instance, in a borehole, elliptical or disc-shaped messenger modules are expected to be preferable although other shapes may be employed. In view of the need for low cost, highly integrated messenger modules that are easily transported in a fluid flow, it is desirable that the largest dimension, on the average, of a messenger module be less than about 5.0 cm. It is preferable that the size be less than about 2.0 cm. Particular applications may require sizes of less than 5.0 mm, and preferably less than 1.0 mm. Suitable housing is desirable to cover messenger modules and protect the electronic circuitry from mud, moisture, and other elements. This housing may completely encapsulate a messenger module, or, in alternative embodiments, provide external electrical contacts and the like, i.e., partial encapsulation. The volume of such a messenger module on the average is preferably less than 1.0 mL. In various applications it may be limited to less than 0.5 mL, down to ranges of about 50.0-5 μL, or less.

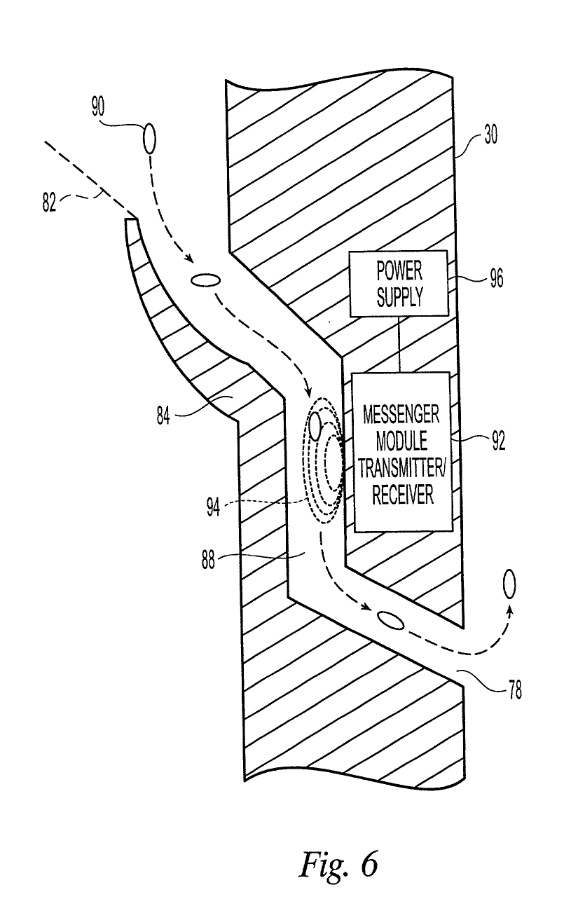

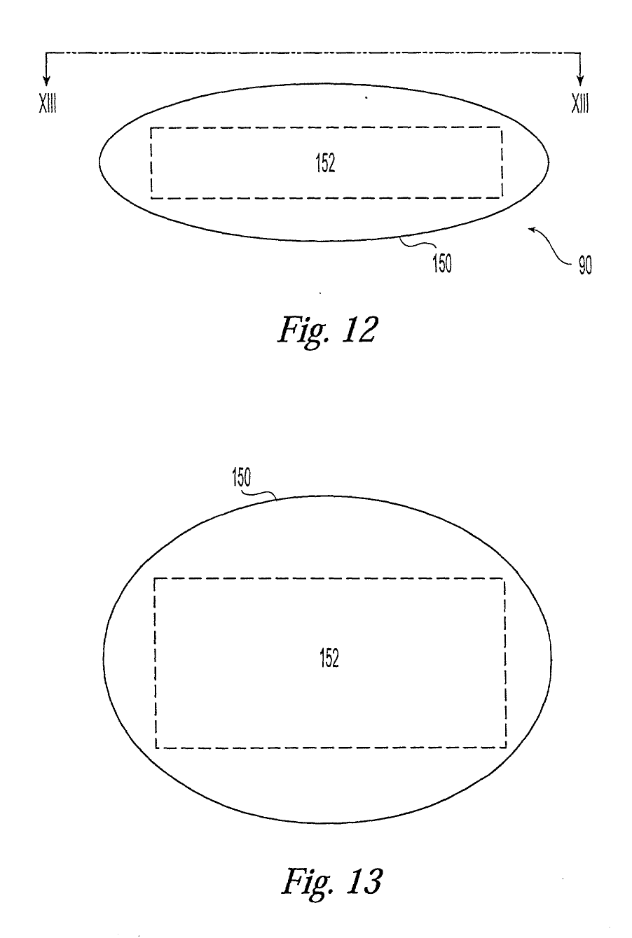

Messenger module 90, illustrated in FIG. 12, comprises sealed housing 150 and circuitry module 152. Housing 150 has a shape, such as an elliptical shape, such that it will assume the required orientation when it is subjected to fluid flow as shown, for example, in FIG. 6. The housing is constructed of a durable material, capable of passing through the mud circulation system with a reasonable likelihood of survival. Housing 150 is also preferably transparent to the transmission from the messenger module transmitter/receiver 92. Thus, if the transmission from the messenger module transmitter/receiver 92 is radiation including electromagnetic and radioactive radiation, the housing should be at least in part transparent to such wireless transmissions. Further, if the transmission from the messenger module transmitter/receiver 92 is optical, the housing should be at least in part transparent to such optical transmissions. If two or more transmission techniques are used, then the housing should in a preferred embodiment be transparent to all such techniques. In a typical application in accordance with this invention, housing 150 may be made of transparent plastic material selected for its durability under the corresponding environmental conditions. Alternative housing implementations for imparting resistance to scratches, moisture, chemicals, temperatures approaching 350° F., and pressures of as much as 20,000 psi include composite coatings that have scratch resistant outer layers, e.g., diamond films, as well as glass layers, and for electromagnetic communications a layer of conducting rubber or plastic. Various modifications to the design parameters of the cover will be apparent to those of skill in the art in a particular application.

As illustrated in FIG. 13, messenger module 90 in a preferred embodiment has a disk shape. Such a shape may be chosen to cause the messenger module to assume the proper orientation as it travels through the fluid flow and in the data transmission chamber. It will be understood that any shape for the messenger module, including a cube, rectangle, sphere, or any other shape, is acceptable as long as the shape does not interfere with the orderly flow of the messenger modules, and preferably facilitates orderly flow of a plurality of messenger modules in the fluid.

5.2.1.3 Circuit Design for a Messenger Module

A very important consideration in many applications of messenger modules used in accordance with this invention is the available power and the manner of its consumption. For reducing power consumption, a direct mapping of a particular function into hardware is preferable with at least the required amount of reconfigurability. Preferably, timers and clocks drive memories, including those for configuring functional blocks into data paths to provide only the capabilities necessary for a particular event. These paths are data-driven, so that functional blocks are only powered up when their inputs are ready resulting in low standby power consumption. One such a data-driven design is described by Brett Warneke and Sunil Bhave in “Smart Dust Mote Core Architecture,” that is a project report for CS252 from Spring 2000 at Berkeley Sensor and Actuator Center, 497 Cory Hall, Berkely Calif. 94720, which report is incorporated herein by reference in its entirety.

A messenger module in accordance with this invention preferably has a memory that can survive power failures, clocks that can run at various rates (i.e., fast and slow) to modulate power consumption while providing responsiveness, and sensors for input that need zero or minimal power during sleep or standby mode. Preferably a messenger module memory is at least 1 kilobytes. The memory size will be dictated by the particular application and is expected to range from tens of kilobytes to tens of megabytes. Future developments in memory technology are expected to push the upper range even further.

As noted, in a typical application any particular messenger module will spend most time in a powered-down state. Further, in addition to low power consumption, various embodiments of messenger modules preferably harvest power from not only input signals, but in addition, or in the alternative, from electrical contacts, vibrations, light, chemical reactions, fluid flow itself, thermal gradients including fluctuating thermal gradients harnessed, for instance, by suitably placed thermocouples, and the like.

5.2.1.4 Suitable Antenna for Various Messenger Modules

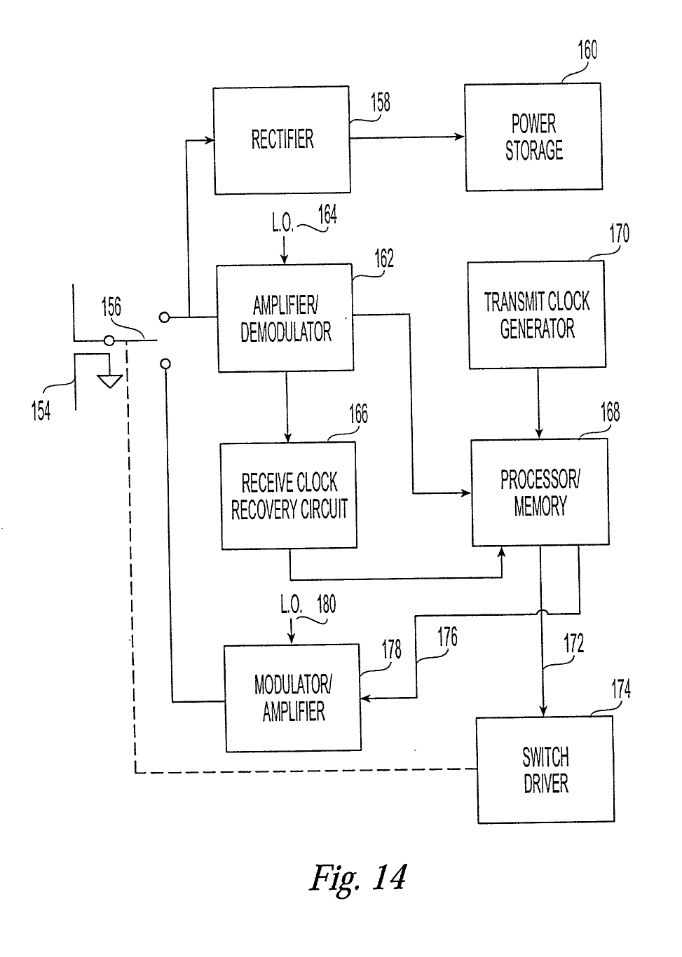

The circuitry for the messenger module, illustrated in FIG. 14, includes transducer 154 capable of transmitting and/or receiving wireless signals. Transducer 154 may be an antenna for transmitting and receiving electromagnetic signals, or a combination of a laser and a photoelectric cell for receiving and transmitting optical signals. Alternatively, transducer 154 may be any sort of transducer, such as an acoustic one, as long as it can receive and transmit the data under the conditions of the particular application.

As illustrated in the embodiment shown in FIG. 14, transducer 154 is coupled to receive/transmit switch 156 to switch the messenger module between a receive mode and a transmit mode. Alternatively, duplex modes may be enabled for both transmitting and receiving.

For non-sinusoidal radiation-based communications described above, transducer 154 generally represents loop antennas, possibly shielded, for avoiding charge accumulations characteristics of bipolar antennas. U.S. Pat. No. 5,748,891 issued to Fleming et al. on May 5, 1998, incorporated herein by reference in its entirety, discloses that it is not necessary to shield a loop antenna for effective transmission of non-sinusoidal radiation and that bi-loop antennas are even more preferable in view of their reduced sensitivity to relative orientation of the transmitting and receiving antennas.

In an embodiment of the invention, impulse pair sequences are transmitted and received using a loop antenna instead of the antenna 154, since current-mode loop antennas are well suited to non-sinusoidal transmissions and their operation is frequency-independent to allow transmission of an ultra-wideband signal without distortion. The far field components of the radiated electric and magnetic fields vary as the product of the length of a single unshielded arm of the loop and the time derivative of the current. Therefore, a device using a loop or bi-loop antenna can be made very small since the lower power supplied to a smaller antenna is compensable by a larger current derivative and communications over shorter distances. The availability of conducting rubbers and plastics suitable for antennas makes possible antennas that are an integral part of one or more housing layers. An example source for such antennas is Antek, Inc., a subsidiary of Integral technologies, Inc. with offices at 805 W. Orchard Drive, Suite 3; Bellingham, Wash. 98225, USA.

An alternate preferred embodiment of the present invention uses a bi-loop antenna to produce transmissions along both axes can be produced with greater flexibility in orienting the antenna. It should be noted that if both the transmission and reception antennas are bi-loop antennas, it is always possible to communicate between the antennas regardless of their relative position and orientation. This property, coupled with suitability for miniaturization makes bi-loop antennas with non-sinusoidal transmissions using pulse pairs suitable not only for messenger modules but for programmer and reader designs as well.

5.2.1.5 Powering a Messenger Module

Previous description of power sources included implementations based on as electrical contacts, vibrations, light, fluid flow itself, chemical reactions, thermal gradients including fluctuating thermal gradients harnessed, for instance, by suitably placed thermocouples, and the like for powering messenger modules. In the case of receiving modules powered by electromagnetic radiation, preferred embodiments of the invention receive high frequency radiation, typically in the Giga Hertz range. Other preferred embodiments may, in addition or in the alternative, also use (micro-)transformers to boost the received voltage to enable rectification of the received signal. Rectification need not be by way of diode-based circuits only, and instead elements with smaller forward voltage drop, such as synchronous rectifiers may be used with suitable triggering of such circuits to effect efficient rectification with low losses.

Another source of power for both disposable and rechargeable messenger modules in accordance with yet another embodiment is in the form of chemical batteries. Advantageously, the battery may be designed to deliver power upon contacting water or other substances. In this context, it should be noted that the power consumption of a memory module can be made very low. An example of a memory product along with power consumption specifications is found, at the time of filing of this application, at http://www.ramtron.com/products/FM25CL64%20Product%20Bulletin.htm These memory modules consume low power, 0.2 mA @ 3.3V at write-time (1MHz clock speed), and function at high temperatures. Additional details for power management follow and are also presented elsewhere in this description.

Since, messenger module 90 may have no internal power source, it is capable of extracting power from the electromagnetic field 94 to power at least some of its internal circuitry. In another aspect of the invention, the need for efficient use of power is reflected in the design of the electronics for messenger modules. For instance, having a high-speed clock consumes significant power. Therefore, a data-driven design is preferred, so that appropriate clocks are started and code blocks executed by powering different circuits in response to data, i.e., actual need. Thus, a messenger module may power off most of its electronics with a needed block powering up in response to a signal received by a receiving circuit. Moreover, the receiving circuit may be powered by the signal itself. Additional blocks are powered-up/down in response to data received and processed in the messenger module.

In alternative embodiments, messenger modules, additionally or in the alternative, may extract power from vibrations and motion due to fluid flow in a manner similar to the technology of self-winding wrist watches driven by the movement of the wrist of the wearer. In this respect it should be noted that micro-machining techniques for semiconductor devices are exploited to build micron-sized structures responsive to vibrations from which power can be extracted. Thus, such power sources are compatible with both the cost and fabrication strategies underlying the messenger module design of the present invention.

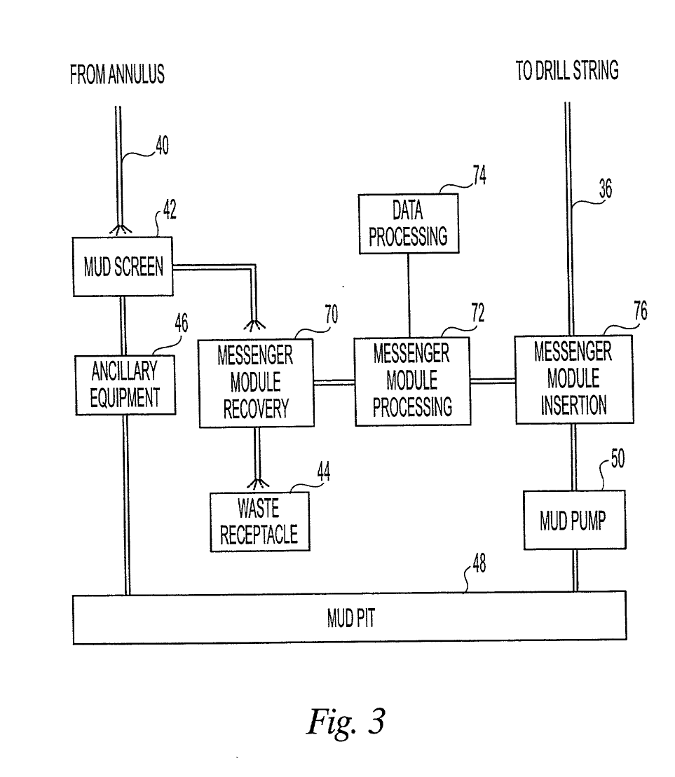

In case a carrier is used for wireless communications, i.e., sinusoidal transmissions, messenger modules may be powered at least in part from the received signal itself Further, in FIG. 6, messenger module 90 includes a receiver and a demodulator (not shown) to demodulate the data from messenger module transmitter/receiver 92. Data is then stored on messenger module 90 before the messenger module is ejected into the borehole annulus through port 78. Messenger module reader or processing device 72, shown in FIG. 3, may include similar equipment to separate the messenger modules, to transmit and receive data to and from them, and to supply power to them.

With reference to FIG. 14, when receive/transmit switch 156 is in the upper position, received signals, such as electromagnetic signals, are coupled to rectifier 158, which rectifies the received signal, converting it into a direct current (DC) signal, which is then used to power the rest of the circuitry in the messenger module and, optionally, charge power storage device 160.

5.2.2 Data Transmission by a Messenger Module

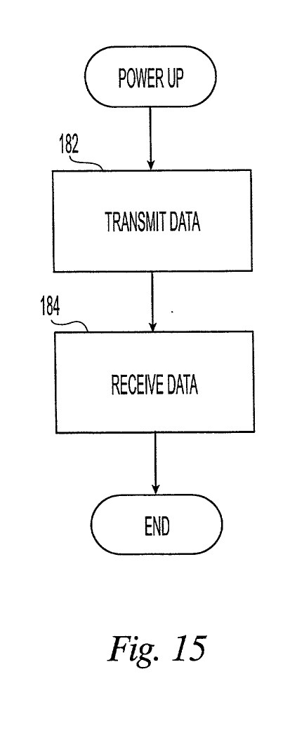

FIG. 15 is a block diagram, showing that in one embodiment when a messenger module detects proximity to a messenger module transmitter/receiver 92, or a reader, it transmits data in its memory (block 182). After it has transmitted data, the messenger module switches to a receive mode (block 184) to receive data from messenger module transmitter/receiver 92. Of course, the order and number of transmitting or receiving operations depends on the particular application and is not intended as a limitation on the scope of the invention.

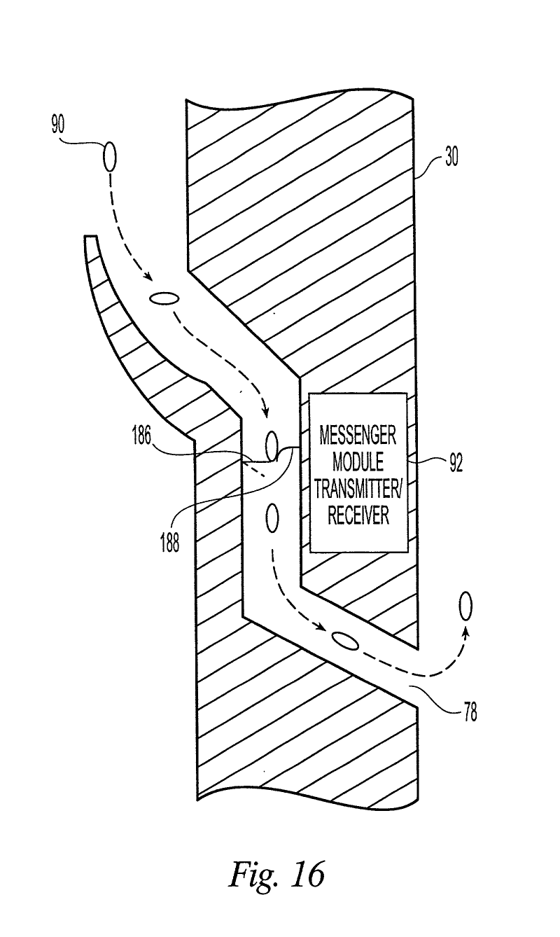

FIG. 16 shows a specific embodiment, in which a messenger module 90 is trapped by a capture device or gate 186 and spring-loaded contact 188. Gate 186 and spring-loaded contact 188, as examples of securing messenger module 90 for data transfer, are configured so that messenger module 90, in an orientation urged by the laminar flow through the data transmission chamber, engages electrical contacts (not shown) on spring-loaded contacts 188. After data transfer, gate 186 assumes the position shown by the dotted line in FIG. 16, allowing messenger module 90 to pass through data transmission chamber.

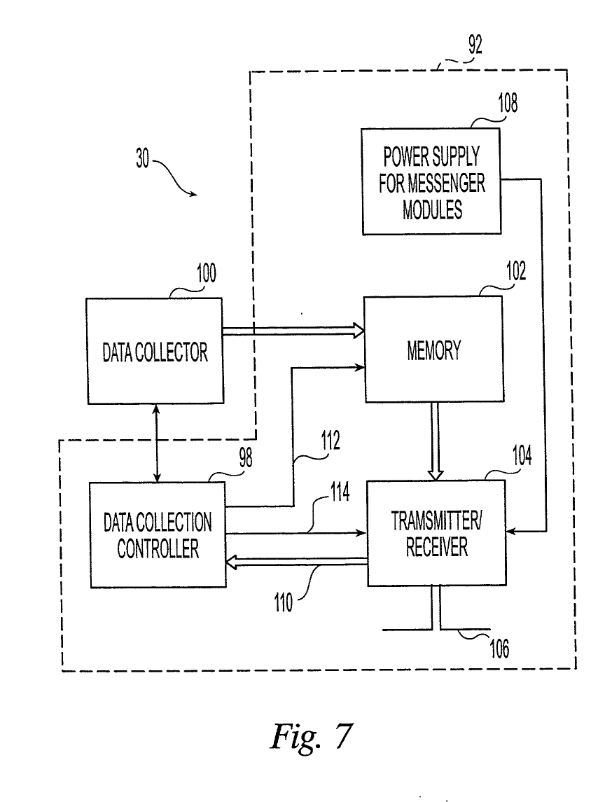

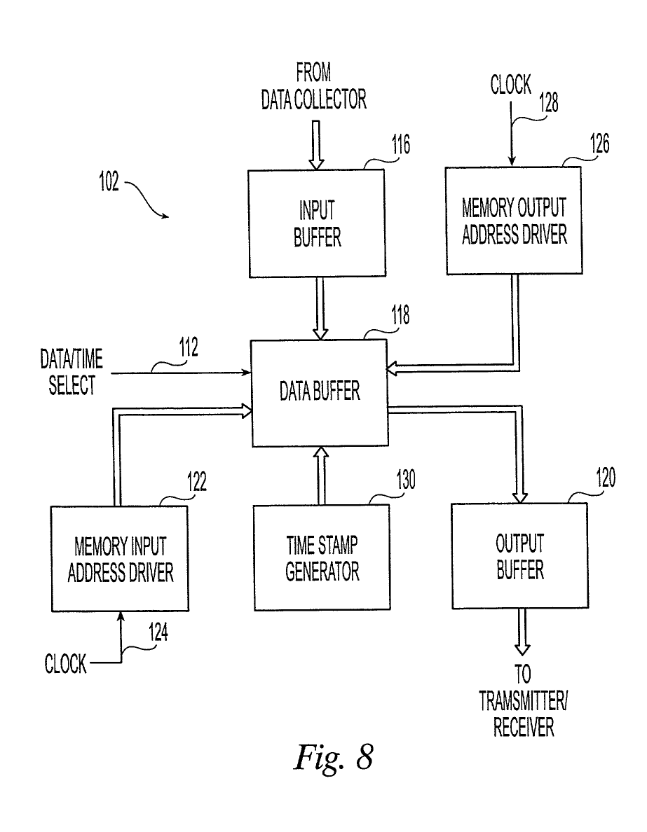

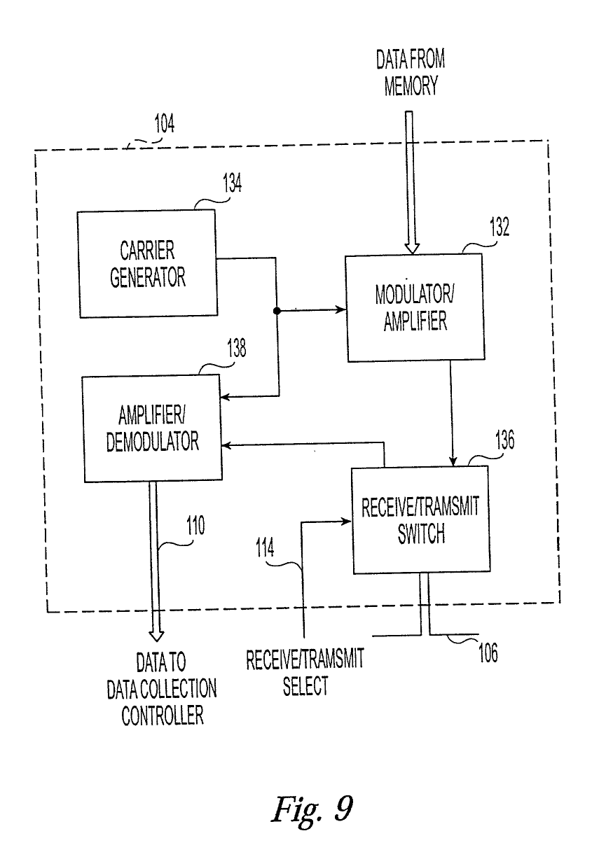

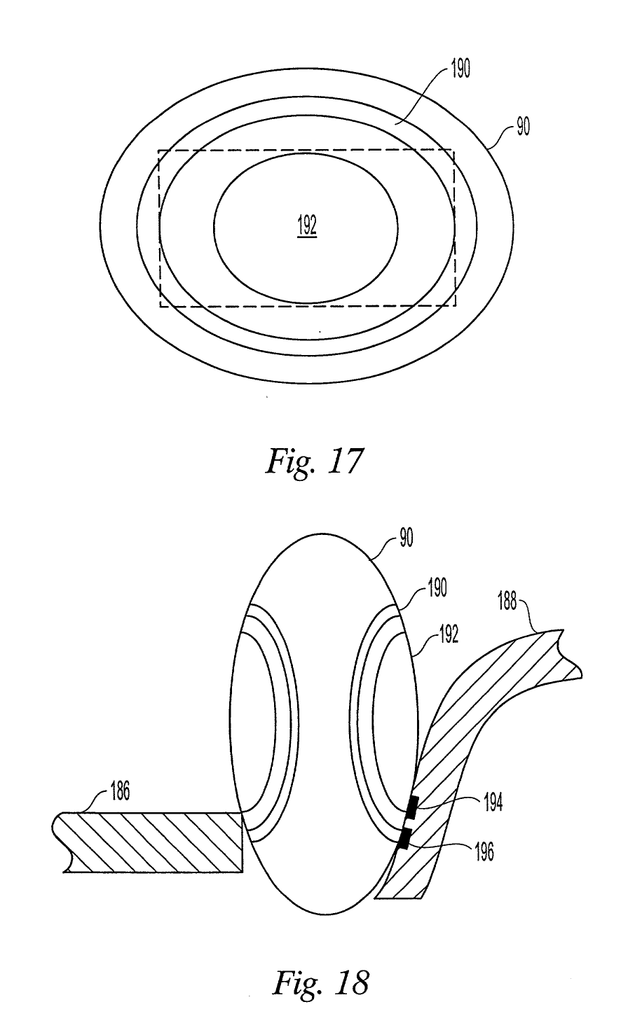

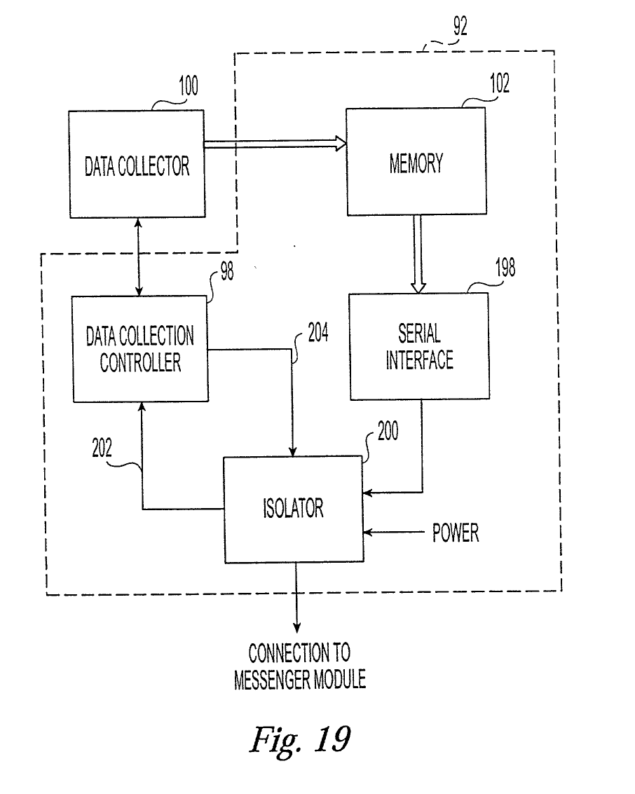

As shown in FIGS. 17 and 18, messenger module 90 in one embodiment has two contacts 190 and 192 mechanically coupled to its outside housing, and electrically coupled to the transducer(s) within its circuitry module. The contacts are configured to make contact with electrical contacts 194 and 196 on spring-loaded contact 188. In this configuration, the circuitry in the messenger module transmitter/receiver 92, illustrated in FIG. 19, includes the same interface to data collector 100 in FIG. 7. Memory 102 receives and stores data from data collector 100 and transmits it through serial interface 198 and isolator 200 to messenger module 90.

5.2.2.1 Wireless Transmissions by Messenger Modules

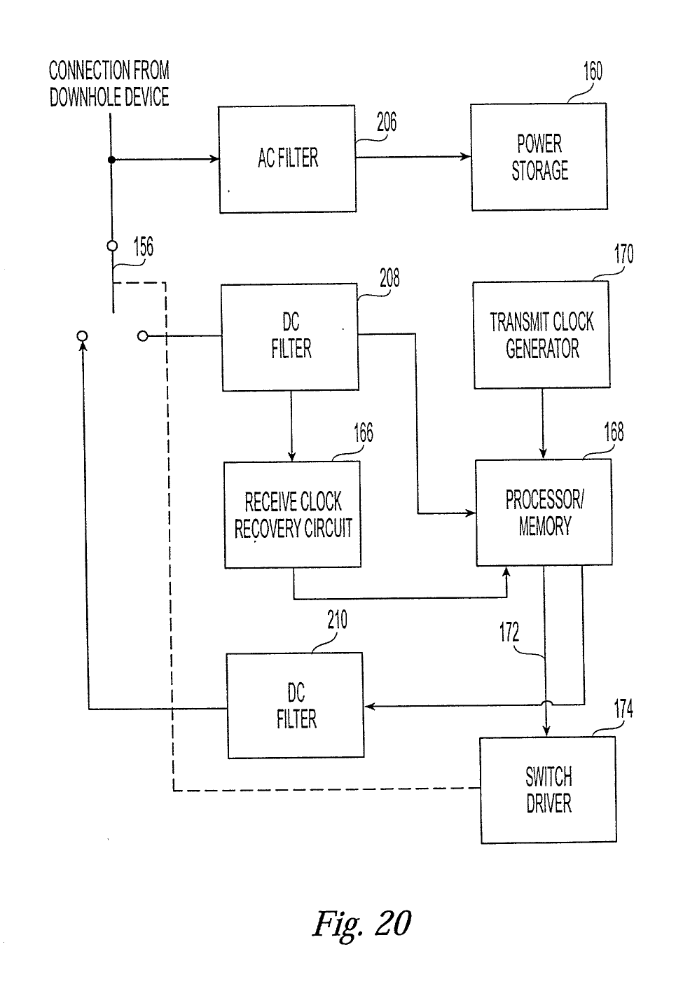

In an alternative embodiment of the invention, the gate approach illustrated in FIGS. 16, 17 and 18 is modified, as illustrated in FIG. 20, to allow wireless transmission, sinusoidal or non-sinusoidal, from messenger module transmitter/receiver 92 to messenger module 90. In the case of a messenger module transmitting data, transmit clock generator 170 causes processor memory 168 to make the data available for transmission.

5.2.2.2 Optical Data Transmission and Reception

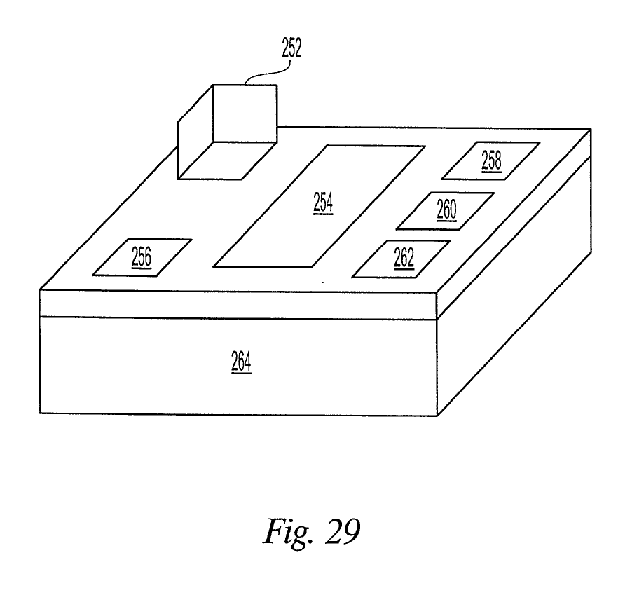

Communication between the messenger module and the messenger module receiver/transmitter can also be accomplished optically, as shown in FIG. 29, which illustrates a messenger module without its protective housing. In this embodiment, a passive transmitter with corner-cube retroreflector 252, in effect requiring no power for receiving a signal, allows transmission of data from the messenger module optically. A retroreflector of this type is described, for example, in Kristofer S. J. Pister, Joseph M. Kahn and Bernhard E. Boser, Smart Dust: Wireless Networks of Millimeter-Scale Sensor Nodes (Dec. 10, 1998), which is incorporated herein by reference in its entirety. It has the property that any incident ray of light from a certain range of angles centered around the cube's body diagonal is reflected back to the source.

Thus, if one of the mirrors is misaligned, retroreflection property would not apply. This property is used to transmit data from the messenger module to the messenger module transmitter/receiver 92 with minimal power expenditure. Thus, a device designed for reading data from the messenger module illuminates it with a light beam, such as from a laser light source. The messenger module then changes the orientation of one or more of the mirrors making up the retroreflector, thereby interrupting the returned beam of light. In this embodiment, the receiving station can then detect the modulations in the light caused by the modifications to the retroreflector and convert it to a data stream.

5.2.2.3 Networking and Data Forwarding by Messenger Modules

It is also possible, although not required for practicing the invention, for messenger modules to receive transmissions from other messenger modules and retransmit this data to other locations, such as to an LWD tool. To this end, messenger modules can form dynamic ad-hoc networks with each other. Such ad-hoc networks generally require execution of instructions in memory for enabling ad-hoc interactions with each other.

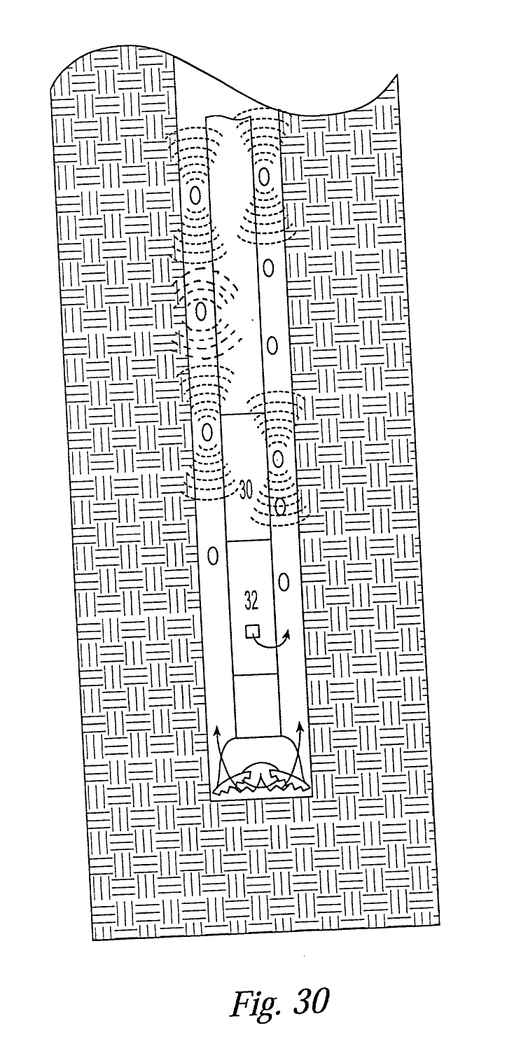

As illustrated in FIG. 30, the messenger modules can be used to relay information. In such embodiments, messenger modules are circulated through the mud channel in the drill string and out of ports in the LWD tools, or through the drill bit and back up the annulus to the surface. A number of the messenger modules are brought to within transmission range from the LWD tools using conventional transmission techniques such as RF and/or optical transmission and/or a contact. In this case, the LWD tools transmit data to these nearby messenger modules. The nearby messenger modules receive the data and retransmit it almost synchronously, on a different frequency (for example, if frequency division multiplexing is used), in a different time slot (for example, if time-division multiplexing is used), by different means (such as receiving electromagnetic radiation and transmitting acoustic energy) or a suitable combination of any of these techniques.

In this embodiment, messenger modules avoid collisions in their transmissions by, for example, waiting a random period of time after receiving data before transmitting it. Messenger modules further up the annulus receive the data and retransmit it using, for example, one of the techniques described above. The transmission of data ripples along the annulus from messenger module to messenger module until it reaches its final destination. In this way, a substantially uninterrupted and (quasi) continuous stream of data may be transmitted from the LWD tools to the surface via a multitude of messenger modules. It will be appreciated that other modes of using the messenger modules for data transmission can be used in alternate embodiments as well.

5.2.2.4 Data Acquisition by Messenger Module Sensors

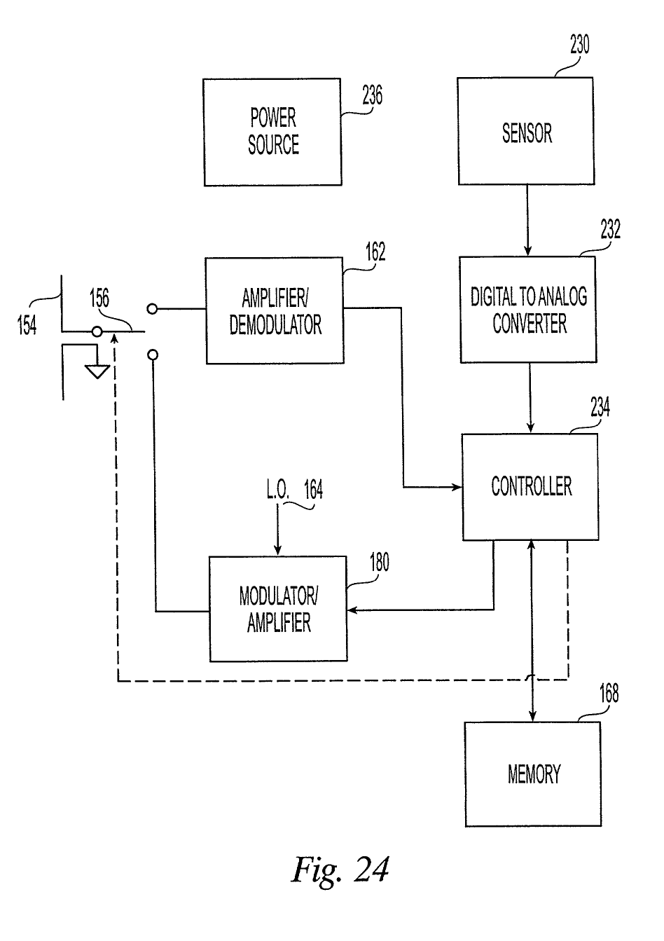

In accordance with a specific embodiment, messenger module 90 may also include sensor 230, as illustrated in FIG. 24. The sensor may sense pressure, temperature, radiation, resistivity, or other parameters dependent on the application. An output of the sensor 230 is typically converted to digital form by digital-to-analog converter 232. The data produced by the digital-to-analog converter 232 is stored by controller 234 in memory 168. The controller then causes this data to be transmitted to a receiver. To this end, modulator/amplifier 180 modulates the data onto a carrier provided by local oscillator 164 and routes the modulated carrier through switch 156 controlled by controller 234. After transmitting the data, the controller 234 switches switch 156 into the receive position. In this position, signals received by transducer 154 are routed through switch 156 into amplifier/demodulator 162 to amplify and demodulate the received signal.

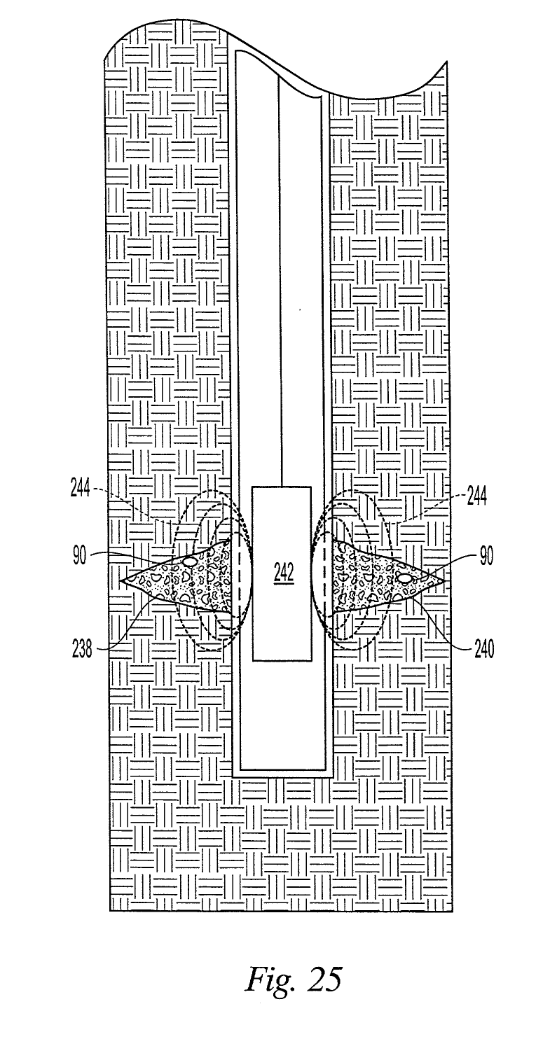

Such sensor-equipped messenger modules, shown in FIG. 25, may be used in a variety of applications. For instance, messenger module 90 placed in fracture zones 238 and 240 for collecting and storing data regarding the formations around the fracture zone and the proppant in the fracture zone during or after positioning of the messenger module.

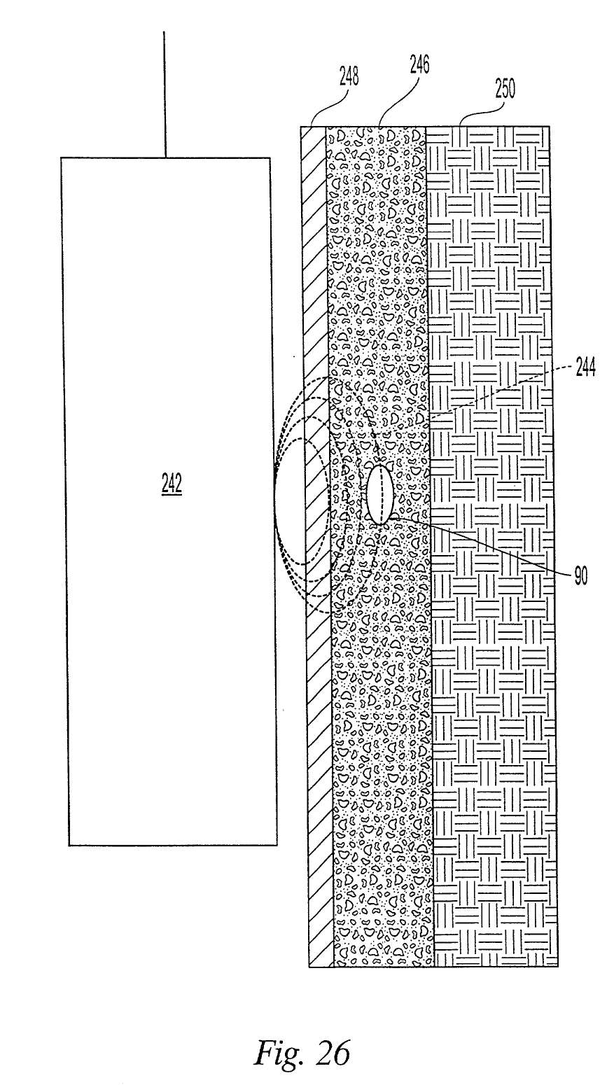

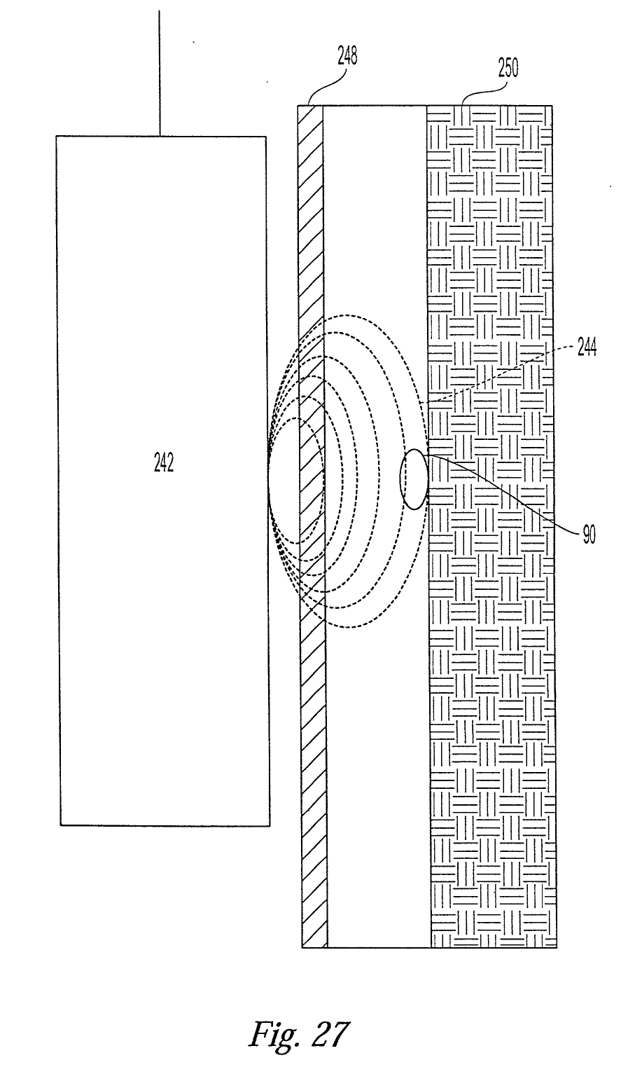

Similarly, as seen in FIG. 26, messenger modules may enable collection of data from behind an oil well casing. Messenger module 90, located in a wellbore in concrete 246 between casing 248 and borehole wall 250 possibly during the curing process, monitors the temperature of the concrete as it cured. Alternatively, messenger module 90 may be in contact with the borehole wall, as shown in FIG. 27, or placed to collect further data regarding the surrounding formations. Tool 242 then receives data from, and possibly powers-up, messenger module 90 when desired and in the vicinity of messenger module 90.

5.2.3 Messenger Module Data Transmitter/Receiver

In accordance with one embodiment, messenger modules interact with a messenger module programmer to receive data inside a borehole. The messenger module programmer of this embodiment, also referred to as a messenger module transmitter/receiver, can both provide data to and, optionally, receive data from messenger modules. Tools and sensors lacking a dedicated messenger module programmer, may communicate with a shared messenger module programmer in order to communicate with messenger modules.

For wireless communications, contemplated modulation techniques in accordance with the principles of the invention include various modulation types, including frequency modulation, amplitude modulation, pulse modulation, spread spectrum techniques, including frequency hopping and modulation using pseudo-random sequences and the like. In alternative embodiments of the invention, data is represented by a sequence of pulse pairs that are transmitted using non-sinusoidal radiation. In alternative embodiments, one form of communications, such as wireless, could be used for transmitting, while another form of communication, such as acoustic, could be used for receiving data. Various other existing or future combinations would be apparent to those of skill in the art and are intended to be covered by the attached claims.

5.2.3.1 Inputting Data Into Messenger Modules

In accordance with the present invention, there may be many ways for a messenger module to receive data, each selected by the specific requirements of the application. Thus, data carried by a single messenger module may originate from two or more sources, and be directed to more than one target. Some of the data may be collected in alternate embodiments by the messenger module itself. In most cases, data may be obtained from a programmer and delivered to another programmer or a reader.

A messenger module programmer in one embodiment of the invention, as shown for example at transmitter/receiver 92 in FIG. 6, generates electromagnetic field 94 in data transmission chamber 88 for providing data to messenger modules. Typically, programmer 92 located in the proximity of one or more tools receives and stores data for messenger modules in memory 102. In response to detecting readiness of messenger module 90, transmitter/receiver 104 will cause data in memory 102 to be transmitted to messenger module 90.

FIG. 7 shows a messenger module transmitter/receiver 92 in accordance with one embodiment of the invention, which includes a data collection controller 98 for coordinating with a data collector 100, such as an acoustic logging tool or a resistivity tool. Once data is stored in memory 102, transmitter/receiver 104 may transmit data via transducer 106. In one embodiment of the invention, transmitter/receiver 104 transmits sufficient power for the messenger modules traveling through the data transmission chamber to power their onboard circuitry.

In a specific embodiment, data may be transferred from messenger module transmitter/receiver 92 to messenger module 90 in segments, especially in situations as shown in FIG. 6. In accordance with FIG. 6, each messenger module 90 receives only a segment of the data transmitted by the messenger module transmitter/receiver 92. It is, therefore, necessary for a messenger module reader to reconstruct the data stream from these data segments when the data is received at the surface.

5.2.3.2 Receiving Data from a Messenger Module

In a specific embodiment, transmitter/receiver 104 is also capable of receiving data from one or more messenger modules. Such data may effect, for example, tool reprogramming, so that surface personnel can dynamically change the operation of downhole tools. In alternative embodiments, data bus 110 connects directly to data collector 100, thereby allowing programming of data collector 100 from the surface. As may be noted, other tools and sensors can be similarly programmed by suitably targeted messenger modules. To this end, the tool being programmed may be programmed to accept data from a messenger module only if the data is directed to it. Alternatively, a messenger module may transit data to a particular tool or sensor in accordance with an addressing scheme. Both of these design possibilities are compatible with low-power consuming data-driven architectures used in various embodiments.

5.2.3.3 Transition between Receiving and Transmitting

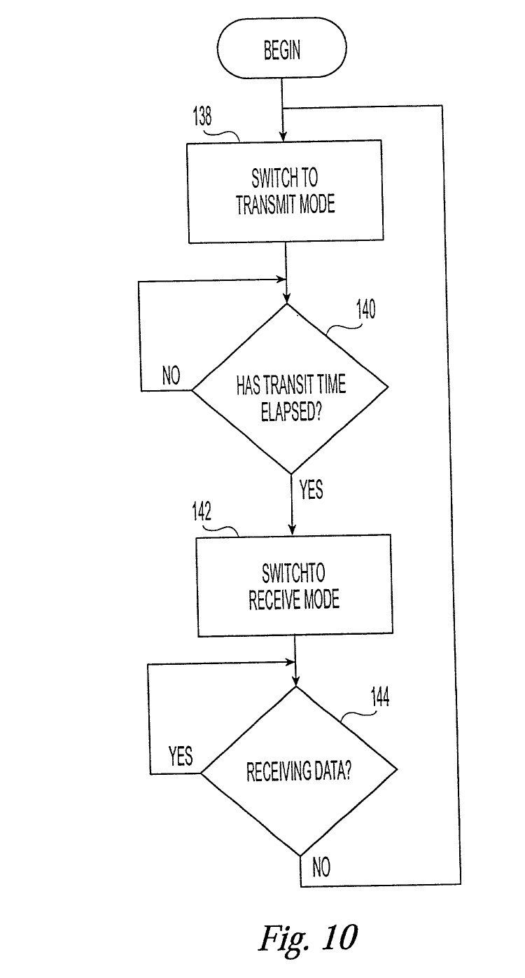

In a specific embodiment, the receiving and transmitting circuits preferably operate in a mutually exclusive manner to reduce noise and cross-talk and to increase sensitivity. As shown in FIGS. 7 and 10, in such case data collection controller 98 may be used to coordinate switching from receiving mode to transmitting mode via signal 114. Initially, data collection controller 98 may switch transmitter/receiver 104 to transmit mode (block 138). Data collection controller 98 may allow a transmit time to elapse (block 140) and then switch transmitter/receiver 104 to the receive mode (block 142). Data collection controller 98 then determines whether it is receiving data (block 144). It can accomplish this function in any number of conventional means, including a detector that detects signals being transmitted by the messenger module 90 or some suitable means for examining the data received from the transmitter/receiver. In a specific embodiment, if it is not receiving data, it switches the transmitter/receiver to the transmit mode (block 138).

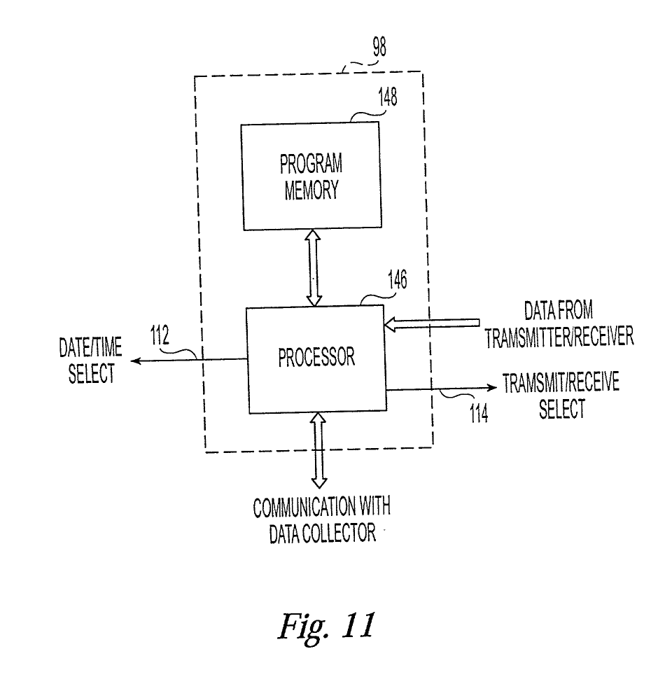

The circuitry of data collection controller 98 illustrated in FIG. 11 includes processor 146, which in accordance with this embodiment can be a microprocessor or combinational logic to accomplish the functions of a microprocessor. Processor 146 may be coupled to program memory 148, which contains the program steps to be accomplished by the processor 146. Program memory 148 may be a flash memory, capable of being reprogrammed and capable of retaining what is stored thereon, even when power is disconnected. Alternatively, the program memory may be a conventional random access memory (RAM), an electrically programmable read-only memory (EPROM), a hard drive, or others.

With reference back to FIG. 11, processor 146 receives data from transmitter/receiver 104, which it then processes. For example, if the required process is to reprogram program memory 148, processor 146 performs that task. Processor 146 may also generate transmit/receive signal 114 and date/time signal 112 according to its programming. Further, the processor communicates with the data collector, as shown in FIG. 11.

The transition of transmitter/receiver 104 between its transmitting function and its receiving function is controlled by data collection controller 98 in response to signal 114. A messenger module could provide signal 114 to indicate data for transmission. As previously described, messenger modules in many embodiments of the invention are in a sleeping state. They wake up in response to detecting a suitable signal indicating presence of a programmer or a reader for data exchange. In data-driven messenger modules, the waking up may also start faster clocks for faster response times on part of the messenger modules.

Preferably, after data is provided to the messenger modules, the transmitter/receiver 104 may be switched to the transmitting state in order to receive data for the next target tool or reader. In a specific embodiment, the received data also may receive a time stamp. In this regard, time stamp generator 130 generates data a time stamp that indicates the order in which data may be arranged in the different messenger modules. In a specific embodiment this stamp is essentially a number showing the place of a particular message in the sequence of messages. In alternative embodiments of the invention, the time stamp may be the actual time when data is generated or loaded onto a module. It may also represent the elapsed time since an event occurred, such as the time when power was first applied to the device or the time when data collection began. Preferably, for redundancy purposes several messenger modules may be used to carry data corresponding to the same time stamp.

5.2.3.4 Ordering Data Based on Time Stamps

In one embodiment, messenger module 90 may be in data transmission chamber 88, illustrated in FIG. 6, and, therefore, be capable of receiving data from messenger module transmitter/receiver 92 for only a particular period of time. Thus, messenger module 90 receives only a particular range 220 of data and time stamps 218. When the data is received at the surface, time stamps 218 are used to reconstruct the data in its original form from several different messenger modules.

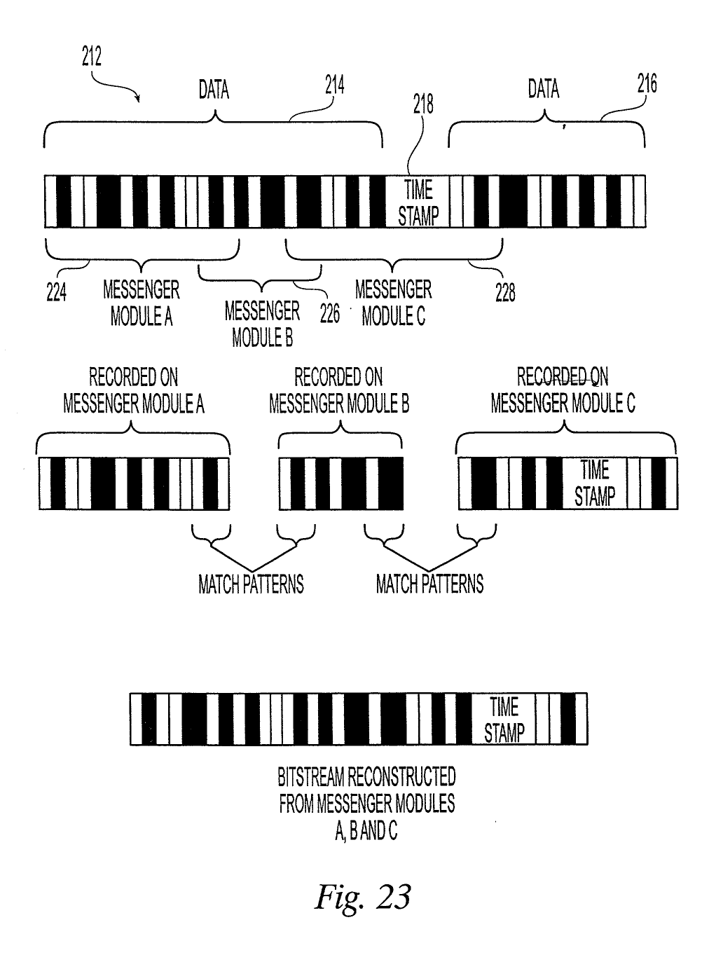

In various embodiments the data may also include error detection and correcting codes 222, as shown in FIG. 22. Such codes include parity bits, check sums, error correcting codes, or others. Alternatively, and especially where there are gaps in the data received on the surface, or where messenger modules arrive at the surface without a time stamp, the original data stream may be reconstructed using patterns within the data itself, as shown in FIG. 23. There, data stream 212 comprises data stream segments 214 and 216 and time stamps 218. Messenger module A carries dataset 224, messenger Module B carries dataset 226, messenger Module C carries dataset 228 that includes time stamp 218. Datasets 224 and 226 overlap, as do datasets 226 and 228. At the surface, the patterns between the data are matched, as shown in FIG. 23, to reconstruct the data. Data streams 224, 226, and 228 are shown in FIG. 23 to have only a few bits. It will be understood that preferably each messenger module will carry substantially more data. Further, FIG. 23 also shows an overlap of only three bits between each data segment. In specific applications, the overlaps may be larger, making the pattern matching easier. It will be appreciated that specific encoding and processing techniques should be selected based on the specifics of the particular application.

5.2.4 Reader for Receiving Data from Messenger Modules

As described above, once data is encoded and transported, a messenger module reader receives the messenger modules. A suitable reader may be implemented as a single device, or may comprise messenger module processing device 72 and a data processing device 74. In one embodiment, messenger module processing device 72 extracts data from the messenger modules and provides the data to data processing device 74. Messenger module processing device 72 may extract data from a messenger module, for instance, by optical, acoustic or radio transmissions without breaking the housing of the messenger module. In alternative embodiments a messenger module processing device may break the housing of the module.

In accordance with this invention, the messenger module reader is similar to the messenger module programmer shown in FIG. 7, and typically may have a generator and a receiver for generating and receiving electromagnetic fields, a demodulator coupled to the receiver, and a memory coupled to the demodulator for storing the demodulated data. It is noted that the electromagnetic field may be generated either continuously, periodically or in some time-defined manner.

As shown in FIG. 7, the messenger module transmitter/receiver 92 includes a data collection controller 98, which coordinates with a data collector 100 that may be any kind of tool, such as an acoustic logging tool or a resistivity tool. The data collection controller 98 coordinates the storage of data by the data collector 100 in memory 102. Alternatively, the messenger module transmitter/receiver 92 may provide a data port through which the data collector 100 can directly manage the storage of data into memory 102.

Once the collected data is stored in memory 102, a transmitter/receiver 104 causes the data to be read out of the memory and to be transmitted via a transducer 106. The transducer 106 can be an antenna, a photoelectric device, such as a laser, an acoustic device, or any other device or combination of devices for transmitting data into the data transmission chamber 88. The data stream transmitted by the transmitter/receiver 104 may include time stamps, which are inserted under the control of the data collection controller 98 via line 112 to memory 102.

In the illustrated embodiment, a power supply 108 provides power to the transmitter/receiver 104, which is transmitted into the data transmission chamber 88, via transducer 106. The transmitter/receiver 104 transmits sufficient power, in some instances, for the messenger modules traveling through the data transmission chamber to power their onboard circuitry. The transmitter/receiver 104 is also capable of receiving data. Such data may, for example, be used to reprogram the processing sequence in the data collection controller 98 or the data collector 100, allowing surface personnel to dynamically change the operation of downhole tools. Data may be transmitted from the transmitter/receiver 104 to the data collection controller 98 via data bus 110. The transition of the transmitter/receiver 104 between its transmitting and its receiving function is controlled by the data collection controller 98 using signal 114. Alternatively, the data bus 110 may connect directly to the data collector 100, thereby allowing programming of the data collector from the surface, and the transition between transmitter and receiver states via signal 112 could be accomplished by the data collector 100.

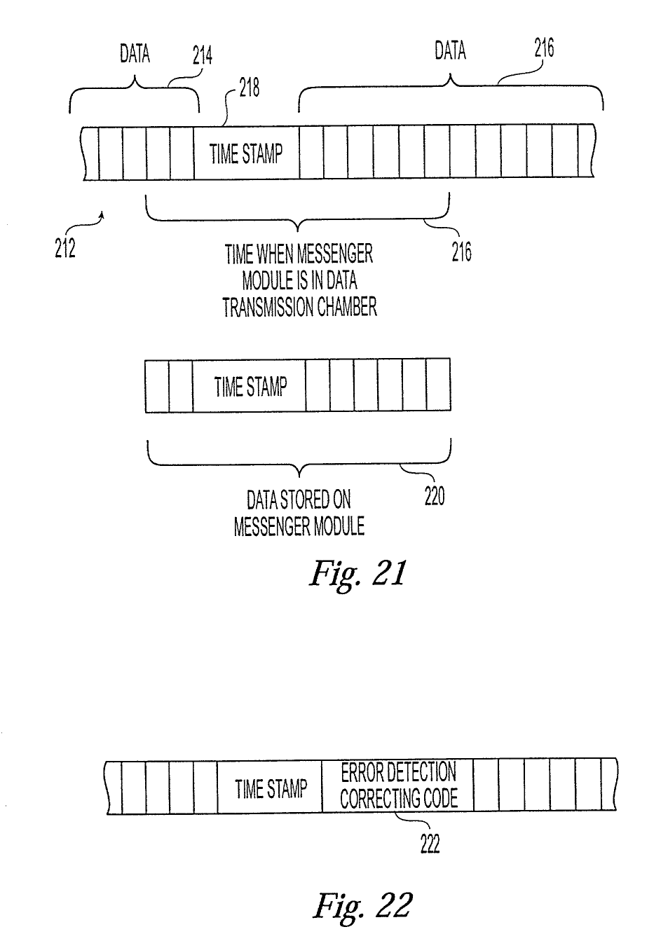

The messenger module reader in one embodiment may include a data stream reconstruction device, configured to reconstruct the data stream from segments of the data stream stored in the memory of the messenger modules. This may be accomplished by the use of time stamps 218, as discussed above and shown in FIG. 21. Data stream 212 comprises segments of data 214 and 216 with time stamps 218 embedded in the segments. Time stamps 218 may be regularly distributed or irregularly distributed through the data prior to transmission into the data transmission chamber. The time stamps may include the actual time of day that the data is being transmitted, the time of day that the data was collected, or some other meaningful time, or they may be sequential numbers, such as “1,” “2,” and so on. As still another alternative, the time stamps may be any decodable signature.

5.2.5 Data Integrity Check

A data integrity monitoring device in accordance with the present invention may be used to screen messenger modules with physical defects or memory errors from the messenger modules with no such defects or errors. The device may comprise one or more messenger modules each having a memory, a messenger module programmer for loading data into the messenger modules, a device for detecting defective modules or memory errors, and a messenger module release device for releasing such messenger modules into a recovery area, separate and apart from the other messenger modules, when the detection device detects a problem. The messenger module programmer, as before, may load data into the messenger module memory through an electromagnetic, optical or other type of connection.

In the event of a failure, a messenger module is advantageously programmed to provide a “dump” of its information upon triggering. Alternatively, a last batch of diagnostic or other information is sent to stave off compromising the communication function to the extent possible. With information of the state of the failure experiencing messenger module, it may be possible to take corrective measures and troubleshoot the problem.

5.2.6 Transport of Messenger Modules with the Aid of a Fluid Flow

As described below, it should be apparent that the principles of this invention can be applied not only to oil well applications, but also to any application with a natural or artificially created fluid flow capable of physically carrying the messenger modules. Messenger modules can often be sampled in any order later to obtain information contained therein. For example, it is envisioned that the principles underlying this invention are applicable for data transport between different points in a pipe, e.g., a pipeline, as well as for communication within a complex system of pipes, within a hydrocarbon processing plant, a water processing plant, a nuclear power plant, a water distribution system, waterways, such as rivers, streams, harbors, ocean currents and floor sediment, hydrothermal springs, winds and combinations thereof to take advantage of various fluid flow systems for communicating data, or others.

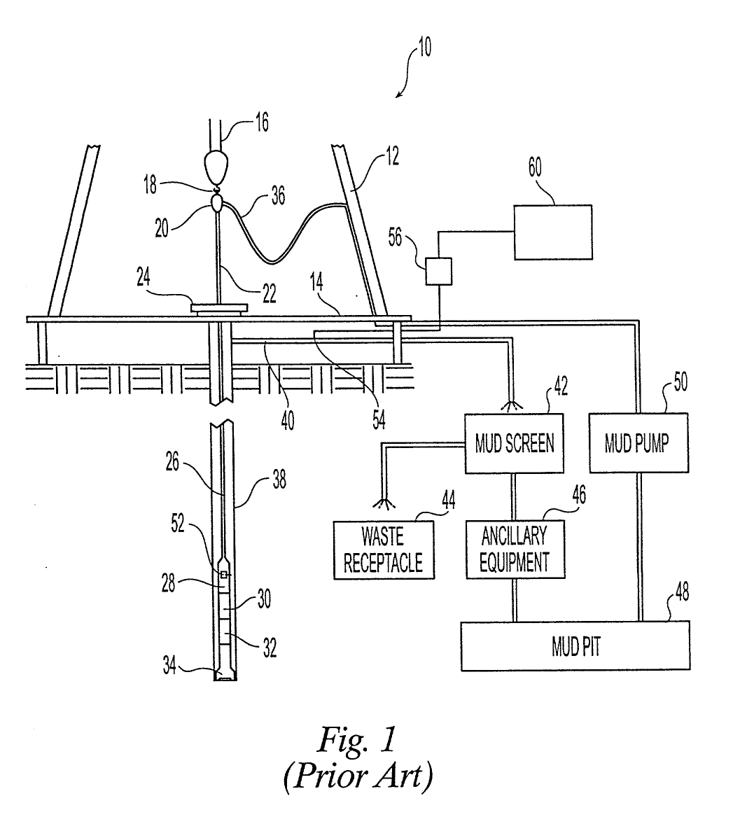

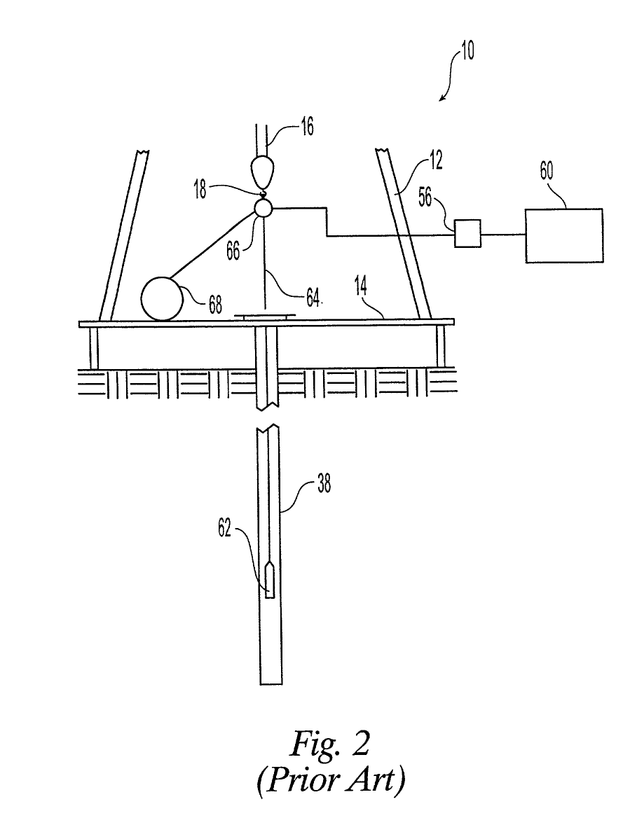

In a preferred embodiment of the invention, the mud flow in an oil well or borehole, e.g., as illustrated in FIG. 1, provides means for transporting modules from the drilling tool to the surface and back. Thus, messenger modules are circulated from the surface to the tool or tools in the borehole where data may be stored on the modules by the tool(s). The modules are then circulated back to the surface, where the data may be retrieved. Alternatively, data may be stored on the messenger module at the surface and then circulated to the tools in the borehole, where the data is retrieved. Still further, data may be stored on the messenger module at one location in the borehole and circulated to a second location in the borehole where the data may be retrieved. Moreover, the messenger modules may include sensors for directly collecting data in the borehole.

It will be understood that the invention is useful not only in oil well applications, but may also be useful in any application where data is to be transported from one location to another, and where there is a circulation system between the locations, including situations where both locations are above ground.

A very different example of the use of the principles of this invention is the investigation of failures or sabotages of complex systems, such as an aircraft. The need for data from an aircraft in the event of a failure provides an illustrative application of the teachings of the invention in the context of combination of various fluid flow systems with delayed sampling of the messenger modules.

Presently, a “black box,” usually painted orange for ease in recovery operations, records all communications and data from various aircraft systems and sensors. This black box contains a tape loop, semiconductor memory or other recording media for saving system information of interest. Often recovering the black box, following a crash, is an expensive undertaking. In addition or in the alternative to the black box messenger modules can act as media for recording system data of interest. Since any particular messenger module may be reused, it is possible to systematically reuse messenger modules so as to retain only the most recent data of interest.

In response to an predefined event, in accordance with the invention, messenger modules carrying all or part of the data, with redundancy built in, can be released for recovery later by sampling air, water, and soil samples at or around sites of interest (see below for details in the context of boreholes). The release of such modules can be in response to mechanical perturbations exceeding preset thresholds, e.g., as in the case of inflation of air-bags in automobiles, or periodic releases. Each messenger module includes identifier information, such as information about the flight, a time stamp, and information sufficient to combine data retrieved from more than one messenger module. Since, the same data may be encoded in several messenger modules, this redundancy protects against destruction or corruption of any particular messenger module. The released messenger modules are transported by fluid flow, such as due to air, water, mud and the like with some of them recovered for subsequent analysis. Thus, even if the black box is not found or is too damaged, sufficient number of messenger modules corresponding to various time points are likely to be recovered from land, water, sediments and the like in a manner akin to processing messenger modules in a borehole described next.

5.2.6.1 Recovery of Messenger Modules from Mud in a Borehole

The handling of messenger modules in the course of communicating data is illustrated in the context of the preferred embodiment of the invention. As noted previously, the scope of the invention is not limited to oil wells or any to boreholes. Turning to FIG. 3, a block diagram depicts the path of messenger modules from above the surface to below the surface and back to the surface in a borehole. Mud returns from the borehole annulus via mud return line 40. Mud screen 42 then separates waste and messenger modules suspended in the mud, and returns the mud to the drill string. The waste and messenger modules separated by mud screen 42 proceed to messenger module recovery device 70.

Messenger module recovery device 70 further separates messenger modules, for instance, with one or more mud screens. In an alternative embodiment of the invention, messenger modules are sufficiently buoyant to be separated from the waste and mud upon settling. Messenger modules are then retrieved using a skimmer or some other device to extract them from the surface. An alternative method uses magnetic separation for messenger module having one or more magnets embedded or attached therein. Such magnets may be in the housing or a layer in the housing and the like. In yet another embodiment of the invention, mud containing messenger modules passes through a series of screens, each successive screen having a smaller mesh than the previous screen, until the messenger modules substantially separate from the other materials. These alternatives are illustrative and should not be interpreted to be limiting on the scope of the invention.

5.2.6.2 Transport of Messenger Modules by Mud Flow in a Borehole

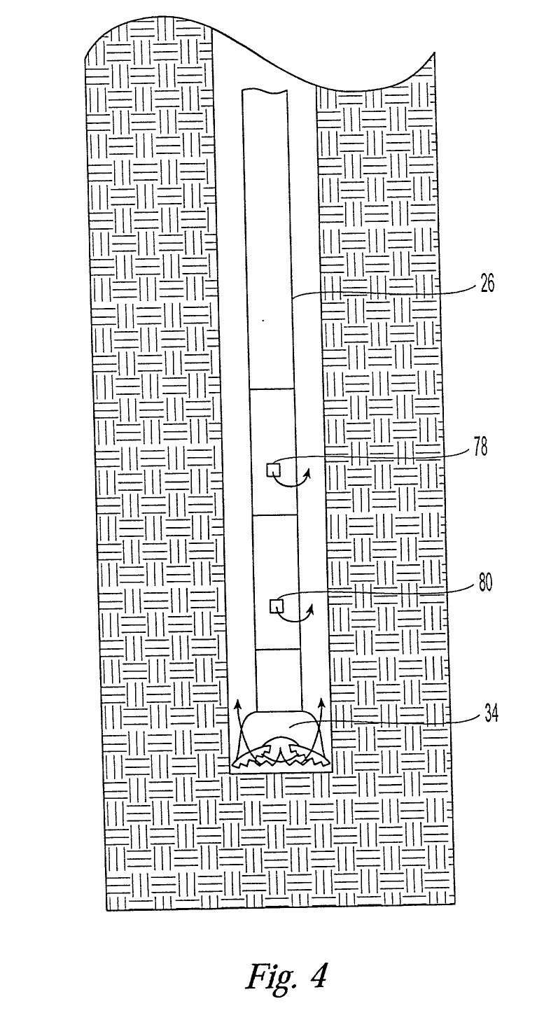

FIG. 4 depicts the interaction of messenger modules with LWD tools. As shown, below the surface the mud flows down the mud channel in drill string 26 and exits through ports in drill bit 34. Some of the mud, including some or all of the messenger modules, is diverted through ports 78 and 80 in LWD tools 30 and 32.

In embodiments of the invention lacking ports 78 and 80, the messenger modules circulate through drill bit 34 after being programmed by LWD tools 30 and 32, and then return to the surface. Although some of the messenger modules will be destroyed by the drill bit 34, the messenger modules that return to the surface will carry data to the surface, including data collected by sensors placed in the messenger modules.

Messenger modules that are not diverted through ports 78 and 80 exit drill string 26 through the drill bit 34. Since many messenger modules may be destroyed in this unforgiving environment, they are designed to be inexpensive, so that a large number can be kept circulating through the mud system to compensate for the destruction of some of the modules by redundancy. Redundant information (required to account for the likely loss of a certain percentage of the memory modules as described above) is discarded resulting in consistent and uninterrupted data transmission.

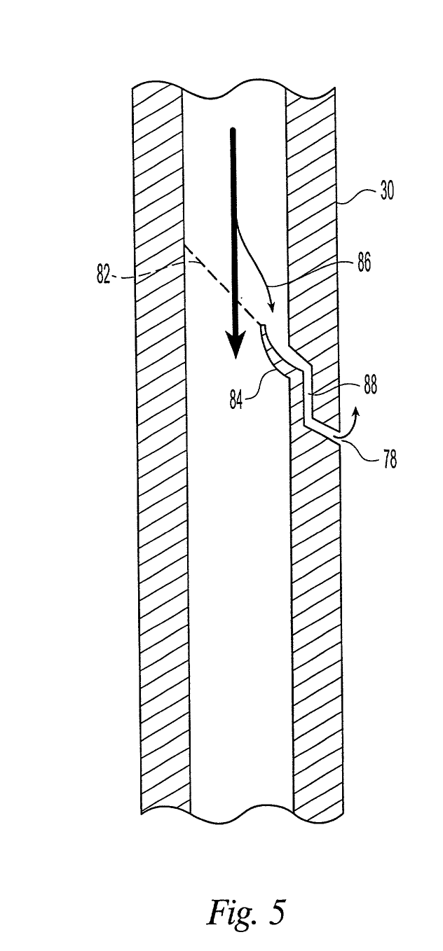

FIG. 5 is a cross-sectional view of LWD tool 30 having screen 82 extending across the mud channel at an angle. The mesh size of screen 82 is small enough to capture some messenger modules, for example, within a range of orientations. The messenger modules that escape screen 82 are available for programming by subsequent tools further down the drill string. The share of messenger modules trapped by screen 82 may be adjusted by changing the mesh size or the pattern of the mesh.

In alternative embodiments of the invention, differently sized messenger modules allow a screen to capture the largest size messenger modules with smaller messenger modules escaping to tools further down the drill string. A second screen in a tool further down the drill string captures smaller messenger modules, and, optionally even smaller messenger modules escaping down the drill string.

Thus, as shown in FIG. 6, screen 82 and diverter 84 cause messenger modules to enter data transmission chamber 88, and then exit tool 30 through port 78. Diverter 84 and data transmission chamber are configured such that the mud flows through the data transmission chamber. Messenger module 90 has a shape, such as an ellipse, such that the flow causes messenger module 90 to preferentially assume an orientation while flowing through data transmission chamber 88. The orientation is chosen to maximize the efficiency of the transmission of data to and from messenger module 90.

5.2.7 Additional Applications of Messenger Modules

5.2.7.1 Detecting Malfunctioning Tools

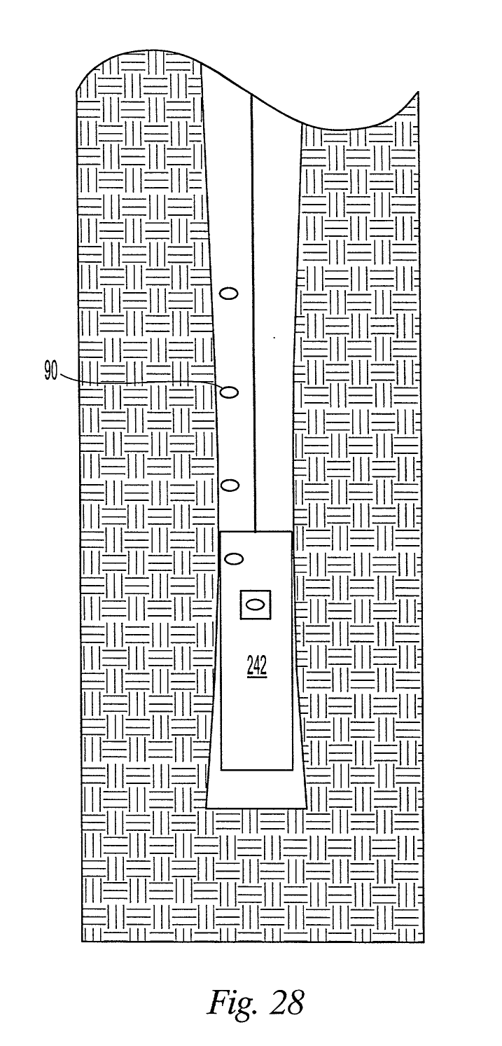

In some embodiments, messenger module 90 can also be used to recover data from stranded tool 242, as illustrated in FIG. 28. Upon becoming stuck in the borehole, as shown in FIG. 28, tool 242 communicates its need to return to the surface via one or more messenger modules 90. Tool 242 then releases messenger modules 90 that are carried to the surface either in a circulatory system or by their own buoyancy in the fluids in the borehole. Preferably, some messenger modules are kept in a vessel within tool 242. The vessel is optionally kept at atmospheric pressure until it is necessary to release messenger module 90.

5.2.7.2 Networking Tools in a Borehole

As previously described, this invention enables various tools and sensors in a borehole to communicate. Thus, it is possible to change the operation of a first tool in response to the resistance or other property sensed by a sensor or second tool or even the failure of a third tool. This automated response is programmable for various terrains due to the additional flexibility provided by messenger modules in inter-tool communications.

5.2.7.3 Obtaining Data to Evaluate Catastrophic Failures

As described previously in the context of aircraft failures resulting in crashes, using messenger modules to provide a media for recording information of interest, similar that in a black box, results in a composite record that can be locally dispersed away from the failure site. The site may be compromised by the mechanical disruption and destructive conditions, such as fire, oil leaks, radiation, high magnetic fields, and the like. Such dispersed messenger modules may be obtained by collecting soil, sediment, water, and mud samples for processing in manner analogous to a borehole. Since the messenger modules are redundant, the destruction of a few modules is tolerable. Even in challenging terrains the sealed messenger modules will hold their information in a sleeping or powered down mode until sampled. Moreover, even if the black box is difficult to locate, or damaged, some messenger modules are far more likely to be recovered. In alternate embodiments, the modules may be incorporated into structural components of the plane or vehicle, which components can be recovered with relative ease.

5.2.7.4 Time Stamps for Measuring Flow Rates

The time stamps carried by messenger modules enable yet another application—both in the borehole and in other settings, such as rivers, oceans and the like. Since many similar messenger modules carry the same data and time stamp/index number when released, detecting the fraction that arrives at a destination point, e.g., the reader, provides an estimate of fluid flow properties between the release point the and the destination. In addition, the messenger modules can obtain information about intermediate conditions, e.g., in a messenger module designed to obtain power by the vibrations received by it in a bore hole, the amount of energy harvested is an estimate of the irregular vibration/turbulence prone flow that it encounters. Even the particular frequencies of vibrations can be detected since micro-machined cantilevers, prepared by either standard lithography techniques or other methods, have natural resonance. Such measurements would both provide valuable mechanical data on an ongoing basis, and also lead to messenger modules that can receive most, if not all, of their power requirements from their surroundings while performing additional tasks.

It will be appreciated that the various features described herein may be used singly or in any combination thereof. Thus, the present invention is not limited to only the embodiments specifically described herein. While the foregoing description and drawings represent a preferred embodiment of the present invention, it will be understood that various additions, modifications, and substitutions may be made therein without departing from the spirit and scope of the present invention as defined in the accompanying claims. In particular, it will be clear to those skilled in the art that the present invention may be embodied in other specific forms, structures, and arrangements, and with other elements, and components, without departing from the spirit or essential characteristics thereof. One skilled in the art will appreciate that the invention may be used with many modifications of structure, arrangement, and components and otherwise, used in the practice of the invention, which are particularly adapted to specific environments and operative requirements without departing from the principles of the present invention. The presently disclosed embodiment is therefore to be considered in all respects as illustrative and not restrictive, the scope of the invention being indicated by the appended claims, and not limited to the foregoing description.

What is claimed is:

1. A method for data transmission in a borehole comprising:
collecting data regarding properties of at least one material;
imparting collected data for storage into a plurality of messenger modules within the borehole, the messenger modules being transported via a fluid flow from a first location to a second location;
collecting transported messenger modules;
retrieving data stored in the collected messenger modules; and
processing the retrieved data.

2. The method of claim 1, wherein the step of collecting data is performed using a logging tool.

3. The method of claim 2, wherein the logging tool is one or more of: neutron, density, sonic, resistivity or nuclear magnetic resonance (NMR) logging tool, acoustic imaging tool, directional sensors, mechanical tools, industrial tools.

4. The method of claim 2 further including the step of drilling the borehole.

5. The method of claim 1 wherein the step of imparting comprises one or more of: electromagnetic, optical or acoustical data transmission to at least one messenger module in the plurality of messenger modules.

6. The method of claim 1, wherein at least one messenger module has a memory for storing data.

7. The method of claim 6, wherein the at least one messenger module further comprises a transducer for receiving data from an external data source for storage in the memory.

8. The method of claim 7, wherein the transducer is capable of receiving data from one or more of: an electromagnetic, an optical, an acoustic data source, and a radiation source.

9. The method of claim 7, wherein the at least one messenger module further comprises a housing configured to protect the memory and the transducer in a borehole environment, the messenger module having physical dimensions enabling the messenger module to be carried in a fluid flow within the borehole.

10. The method of claim 1 further including imparting a signal for powering an on-board electronic circuit in at least one of the plurality of messenger modules.

11. The method of claim 1, wherein the fluid flow is an artificially created fluid flow.

12. The method of claim 1, wherein the step of retrieving data stored in the collected messenger modules comprises transmitting data stored at the messenger module to the detected receiver in response to detecting presence of a data receiver.

13. The method of claim 1 further comprising the step of imparting to at least one messenger module at least one programming instruction for modifying operation of a downhole tool followed by releasing the at least one messenger module in the fluid flow to carry the at least one messenger module into vicinity of the tool.

14. The method of claim 13 further comprising the steps of receiving the released at least one messenger module at the tool, and programming the tool in accordance with the at least one instruction retrieved from the at least one messenger module.

15. A method for operating one or more tools deployed in a borehole, comprising:
providing a sequence of instructions concerning a desired operation of a tool in the borehole;
imparting the generated sequence of instructions for storage into one or more messenger modules, the messenger modules having dimensions enabling them to be carried in a fluid flow within the borehole;
releasing the one or more messenger modules with stored instructions in a fluid flow within the borehole, the path of the fluid flow carrying such messenger modules near the tool;
retrieving messenger modules released in the fluid flow at the tool;
extracting the generated sequence of instructions from one or more messenger modules retrieved at the tool; and
programming the operation of the tool to conform with the provided sequence of instructions.

16. A method for gathering data regarding material(s) inside or surrounding a borehole comprising:
providing a plurality of messenger modules having dimensions enabling them to be carried in a fluid flow within the borehole;
gathering data concerning properties of the formation using one or more sensors located in a messenger module, and storing the gathered data in the messenger module;
collecting one or more messenger modules with stored data in the fluid flow within the borehole;
retrieving data stored in the collected messenger modules; and
processing the retrieved data to determine properties of the geologic formation surrounding the borehole.

17. A data transmission system, comprising:
a plurality of messenger modules for storing data, the messenger modules having
physical dimensions enabling them to be carried in a fluid flow; and
at least one reader responsive to a member of the set consisting of electromagnetic signal or acoustic signal, positioned in a predetermined fluid flow path, the reader configured to receive data stored in a messenger module that is carried by the fluid flow near the reader.

18. A messenger module having a plurality of circuits for use in a data transmission system assisted by a fluid flow, the messenger module comprising:
a memory for storing data;
a receiver for receiving data from an external source;
a transmitter for providing data to an external sink;
a housing; and
at least one sensor for detecting the external sink.

19. The messenger module of claim 18 further comprising: at least one clock.

20. The messenger module of claim 19 further comprising: a second clock such that slower clock from the second clock and the at least one clock is operational when the messenger modules is in a sleep state.

21. The messenger module of claim 18 further comprising a no clock mode of operation.

22. The messenger module of claim 18 further comprising: at least one power storage device.

23. The messenger module of claim 22 further comprising: a power generator, coupled to the at least one power storage device for converting one member of the set consisting of external vibrations, thermal energy, and optical energy, into power for driving at least one circuit from the plurality of circuits.

24. The messenger module of claim 18 wherein furthermore the housing has a largest dimension not exceeding 5.0 c.m.

25. The messenger module of claim 18 wherein furthermore the volume of the messenger modules does not exceed 1.0 ml.

26. The messenger module of claim 18 having furthermore a disc-like shape suitable for transport by the fluid flow.

27. The messenger module of claim 18 having furthermore a cigar-like shape suitable for transport by the fluid flow.

28. The messenger module of claim 18 wherein furthermore the memory includes at least 1.0 megabytes.

29. The messenger module of claim 18 further comprising a bi-loop antenna for non-sinusoidal transmission of data.

30. The messenger module of claim 18 wherein furthermore the receiver receives data from another messenger module.

31. The messenger module of claim 30 wherein furthermore the memory has computer executable instructions for carrying out the steps of a method for forming an ad-hoc network with the another messenger module.

32. The messenger module of claim 31 further comprising a processor for executing at least one of the computer executable instructions.

33. A system for transmission of data in a borehole comprising:
a plurality of messenger modules storing data, the modules having physical dimensions enabling them to be carried in a fluid flow;
a data transmission device receiving fluid from the fluid flow, the device capable of loading data to messenger modules located in its vicinity;
a receiver collecting data stored in messenger modules and transmitting the collected data for processing.

34. A system for transmission of data in a borehole comprising:
a plurality of messenger modules storing data, the modules having physical dimensions enabling them to be carried in a fluid flow;
a data transmission device receiving fluid from the fluid flow, the device capable of loading data to messenger modules located in its vicinity;
a receiver collecting data stored in messenger modules and transmitting the collected data for processing.

35. A method for data transmission from a logging tool in a borehole, comprising:
collecting data regarding properties of a material inside or surrounding the borehole;
providing an indication of at least one of: the position of the tool in the borehole and the operation of the logging tool;
detecting a tool emergency based on the provided indication;
imparting collected data for storage into one or more messenger modules having dimensions enabling them to be carried in a fluid flow and releasing the one or more messenger modules in a fluid flow of the borehole;
collecting one or more messenger modules having stored data in the fluid flow;
retrieving data stored in one or more collected messenger modules; and
processing the retrieved data to determine at least one of: properties of materials inside or surrounding the borehole and information about the tool emergency.
